(19) United States
(12) Patent Application Publication
(10) Pub. No.: US 2015/0353163 A1
(43) Pub. Date: Dec. 10, 2015

(54) FLEXIBLE MEMBERS AND FLEXIBLE MEMBER ATTACHMENT POCKETS FOR A VEHICLE SUSPENSION SYSTEM

(71) Applicant: LAUF FORKS EHF, Reykjavik (IS)

(72) Inventor: Benedikt SKÚLASON, Reykjavik (IS)

(73) Assignee: LAUF FORKS EHF, Reykjavik (IS)

(21) Appl. No.: 14/760,597

(22) PCT Filed: Jan. 3, 2014
(86) PCT No.: PCT/IS2014/000001

§ 371 Date: Jul. 13, 2015

Related U.S. Application Data
(60) Provisional application No. 61/751,466, filed on Jan. 11, 2013.

(30) Foreign Application Priority Data
Mar. 25, 2013 (IS) 9027

(51) Int. Cl. B62K 25/24

(52) U.S. Cl. CPC B62K 25/24

(57) ABSTRACT

This invention relates to a vehicle suspension system where two or more flexible members are arranged in a non-planar way with a distance there between. These flexible members are being rigidly mounted between a frame structure of a vehicle and a wheel structure of the vehicle and the arrangement of the flexible members is so as to provide guided suspension and being resistive against forces other than those in the intended direction of the suspension movement.

The present invention relates to a vehicle suspension system, especially flexible members and flexible member attachment pockets of said vehicle suspension system and to a vehicle comprising such a suspension system.

### BACKGROUND OF THE INVENTION

Today's bike (bicycles and motorbikes) suspension systems utilize telescopic sliding surfaces to guide the compression of its suspension and damping unit (called shock here after). The suspended wheel can be connected directly to the telescopic shock, as is the case with most front suspension systems. The suspended wheel can also be connected to the shock through links and pivots, gearing up or down the forces and displacement the shock experiences while reducing perpendicular loads on the shock, as is usually the case with rear wheel suspension systems. Modern telescopic shocks most commonly utilize either springs or compressed air for suspension and hydraulics for dampening.

While modern air-sprung telescopic suspension systems are fairly lightweight and perform acceptably, they can't escape the heft and friction of its telescopically sliding surfaces and/or links and pivots. The friction in the sliding surfaces and pivots demands a relatively tight maintenance schedule, and associated cost for the user.

In the case when the shock is connected directly to a suspended wheel the shock has to be very strong to be able to take up the forces, perpendicular to the sliding direction of the telescopic suspension system, it encounters. Furthermore, the telescopic suspension system has to be fairly long to allow for the required suspension travel. This results in increased weight. Additionally, telescopic suspension systems are limited to in-line movements throughout its suspension range.

However, if the shock is operated through links and pivots connecting it to the suspended wheel, the shock itself can be made smaller and lighter, but the weight of pivots and links is added. Also, adding pivots requires maintenance of these pivots.

Furthermore, the static friction of telescopic shocks and pivots makes it hard for them to absorb small hits and the initial spike of larger hits.

DE920651 and FR985718 describe a front wheel suspension system for bicycles that achieves suspension through the flex of flexible members without telescopic shocks and pivots. The described configurations do however deal poorly with lateral forces, during e.g. aggressive riding of a bicycle through a turn. The suspended wheel of DE920651 and FR985718 is susceptible to move backwards out of the desired path of the suspension movement during frontal loads on the suspended wheel and its flexible members are susceptible to buckling during frontal loads on the suspended wheel. These configurations are not highly responsive towards frontal impacts during the initial part of the suspension travel, making them respond poorly to small bumps. However, in the final part of its suspension travel they undesirably become more responsive towards frontal impact, i.e. they have a reversely progressive spring rate. These references furthermore do not have any means of absorbing excessive rebound energy of the suspension system, making the system susceptible to undesirably vibrate around its rest position, e.g. when the suspended wheel does not have contact with ground when jumping or after hitting larger obstacles. Additionally, these references do not have any bump-stop means, making the flexible members of these references susceptible to mechanical failure when the suspension system encounters extreme loads.

DE920651 and FR985718 connect the lateral sides of its wheel structure together via a rigid connection above the suspended wheel. This requires the wheel structure to extend all the way from the hub connection and up above the suspended wheel to the said connection. If the lowest springs of the systems are located far down on the fork legs then the fork legs obviously have to reach down to these springs, creating a system with a double structure over a substantial length, resulting in added bulk and weight of the system. If the lowest springs are located further up on the fork legs, then this additional bulk and weight can be avoided since the said fork legs now don't have to be as long. However, this means that the spring system becomes located further from the ground, further from the force input into the system, resulting in less compliance with forces in other directions than the intended suspension movement direction of the suspended wheel.

Based on the above, these references do not present a viable replacement option for conventional suspension systems utilizing telescopic sliding surfaces and or links and pivots.

The inventor of the present invention has appreciated that there is thus a need for an improved and simplified suspension system without said supplementary means of suspension guiding such as sliding surfaces, links and pivots and has in consequence devised the present invention.

### SUMMARY OF THE INVENTION

It would be advantageous to achieve a simplified suspension without the supplementary means of suspension guiding that requires less maintenance and has a better response to excitation and eliminates the weight of additional components. In general, the invention preferably seeks to mitigate, alleviate or eliminate one or more of the above mentioned disadvantages singly or in any combination. In particular, it may be seen as an object of the present invention to provide a suspension mechanism that solved the above mentioned problems, or other problems, of the prior art.

To better address one or more of these concerns, in a first aspect of the invention a front wheel vehicle suspension system is provided comprising:
a frame structure including a two legged fork,
   wherein the front wheel vehicle suspension system further comprises:
a wheel structure comprising wheel structure beams positioned posterior to the two legged fork,
two sets of at least two spaced apart flexible members extending between the respective one of said two legs of said two legged fork and said wheel structure beams such that said two sets of flexible members are located on respective lateral sides of a suspended wheel,
   wherein each of said wheel structure beams comprises hub mounts located above one or more out of said at least two flexible members on each side of the suspended wheel and below one or more out of said at least two flexible members on each side of the suspended wheel and where said hub mounts are positioned opposingly to each other and are adapted to receive a connection to one another via the hub of the suspended wheel, where each of said flexible members is mounted into attachment pockets in said two legged fork and said wheel structure beams.

Accordingly, a suspension system is provided where the flexible members can provide suspension without supplementary means of suspension guiding, i.e. sliding surfaces and/or links and pivots, which makes the suspension system almost maintenance free. Also, the response to excitation is greatly enhanced and the weight of additional components such as telescopic arms and/or links and pivots is eliminated which reduces the weight of the suspension system. The weight of the suspension system according to the present invention which may i.e. be made of any type of composite material may, for example in the case of usage on a mountain bike with 29 inch wheels be below 1000 g, whereas the weight of the most advanced telescopic suspension systems is around 1300-1400 g, which is obviously an enormous reduction in weight. Low weight is a very valuable property of bicycle components, especially in competitive cycling such as cross-country or marathon mountain biking. Low weight makes a bicycle more maneuverable and makes it require less energy from the rider to propel it.

Thus, a suspension mechanism is provided on both sides of the front wheel with a rigid connection between the sides, which significantly increases the lateral stiffness of the front wheel suspension system.

Also, since the hub mounts are located above one or more out of said at least two flexible members on each side of the suspended wheel and below one or more out of said at least two flexible members on each side of the suspended wheel (when the rotational axis of the suspended wheel is parallel to the ground and front and rear wheels of said vehicle both in contact with ground), e.g. above three (could be fewer or more than three) flexible members and below three (could be fewer or more than three) flexible members, it follows that the front wheel suspension system is located closer to the ground, where the input forces into the suspension system come from making the lever arm of the forces towards the suspension system smaller.

Since said suspension system of the present invention has its only connection, preferably a rigid connection, between its lateral sides of the suspended wheel via the hub, the wheel structure does not have to reach up above the suspended wheel to make a rigid connection between its lateral sides there. Thus, the weight of the suspension system can be reduced.

The flexible members may according to the present invention all be connected to the wheel structure well within a radius from the hub that is less than the radius to the outmost edge of the suspended wheel, such as, but not limited to, less than 0.7*(radius from hub to the outmost point of suspended wheel), e.g. between 0.30 to 0.55*(radius from hub to the outmost point of suspended wheel), such as around 0.4*(radius from hub to the outmost point of suspended wheel).

During suspension where the said hub mounts are located anteriorly relatively to flexible member attachment pockets of said wheel structure the distance from the adjacent flexible member of the said one or more flexible members located below said hub mounts increases. This enables placing the adjacent of said flexible members located below said hub mounts close, e.g. 15 to 50 mm, to the said hub mount without risking the wheel structure hitting the said flexible members during suspension travel. This places the suspension system closer to the ground, where the input forces into the suspension system come from making the lever arm of the forces towards the suspension system smaller.

Placing the flexible member attachment pockets of said wheel structure posteriorly to said hub mounts enables using longer flexible members for a given forward reach of said two legged fork of said frame structure of said front suspension system.

For a given spacing between said at least two flexible members the present invention makes the suspension better suited to resist forces other than those in the intended direction of the suspension, e.g. lateral forces encountered during e.g. aggressive riding of a bicycle through a turn.

As already addressed, said hub mounts are adapted to receive a connection, preferably a rigid connection, that rigidly connects said wheel structure beams together, therefore making them move as one during suspension. Said connection may be any type of rigid connection such as, but not limited to, a rod made e.g. of aluminum, titanium, magnesium, steel or a composite material such as carbon fiber, boron fiber, flax fiber, glass fiber, basalt fiber or Kevlar fiber. The result of such a rigid connection is that the front vehicle suspension system becomes stiffer and more resistant against lateral input forces.

As already stated, said hub mounts are adapted to receive a connection to one another via the hub of the suspended wheel. By the term “via” it is meant that the said connection may extend between the hub mounts and/or partly into one or both of the hub mounts and/or through one or both of the hub mounts, e.g. the connection may extend partly into one of the hub mounts and fully through the other hub mount. Any type of means may be provided to make said connection between the hub mounts. As an example, the inner side of one or both of said hub mounts may be provided with a thread that said connection engages with via corresponding thread on the outer side of said connection rod tightening the said hub mounts to the hub of the suspended wheel.

The term wheel structure beams, which may be two wheel structure beams, may according to the present invention mean structures of any type and shape, e.g. a straight elongated structure, or a structure that may be curved in any way, e.g. that has a V or U-shaped side view.

The term frame structure may be interpreted to be the main frame of the vehicle, e.g. bicycle, and the part of its attached two legged front fork that is connected in a non-flexible manner to the main frame of said vehicle.

In one embodiment, said flexible members are substantially flat plates, the dimensions of the cross section being such that the width is substantially greater than its height. Said width is substantially parallel to ground when the rotational axis of the suspended wheel is parallel to the ground and front and rear wheels of said vehicle both in contact with the ground. Said dimensions give increased resistance against forces other than those working in the direction of the intended suspension path. Being a substantially flat plates, rather than being e.g. a curved flexible members as described in prior art systems, said flexible members are less likely to buckle under frontal load of the suspended wheel and the suspended wheel is further constrained from moving backwards out of the desired path of the suspension movement during frontal load on the suspended wheel.

In one embodiment, said at least two flexible members are of substantially equal length and are arranged in a substantially parallel way. It is thus ensured that the stresses in the flexible members are distributed optimally.

In one embodiment, said at least two flexible members extend, in relation to the wheel structure, in an upwards direction from said wheel structure and forward towards the two legged fork of said frame structure, when the rotational axis of the suspended wheel is parallel to the ground and front and rear wheels of said vehicle both in contact with ground.

In one embodiment, said front suspension system has its said at least two flexible members extending from said two legged front fork of said frame structure to said wheel structure rearwards and downwards by an angle of, but not limited to, between 5° to 25°, such as 10°-20° relatively to a plane perpendicular to a line running through the front suspension system fork's steerer tube.

Thus, in comparison to prior art systems, making the said suspension system more responsive to frontal impacts during the initial part of the suspension travel path while both giving it a progressive spring rate towards frontal impact further into the suspension travel path and being capable of having higher maximal suspension travel. Furthermore this configuration of the present invention makes the said at least two flexible members less likely to buckle under frontal loads than in prior art systems.

In one embodiment, said at least two flexible members form one or more bundles of closely spaced flexible members. Accordingly, stacking the flexible members up in closely spaced bundles enables them to flex further than a single thicker member could do while being able to carry the same maximal load. Where the term closely spaced refers to, but is not limited to, a spacing of 1 mm to 30 mm, such as 1-10 mm.

In one embodiment, the suspension system further comprises an upwardly extending damper, when said vehicle suspension system is in a vertical position in relation to the ground, i.e. the rotational axis of the suspended wheel being parallel to the ground and front and rear wheels of said vehicle both in contact with ground, arranged from the wheel structure to the frame structure. Hence, further control of the dynamics of the suspension is provided by means of absorbing compression and rebound energy where desired and a lock-out function possibility of the suspension is provided.

In one embodiment, said at least two flexible members of said suspension system connecting the wheel structure to the frame structure are substantially laterally symmetric around the respective suspended wheel. This provides a balanced and guided suspension response to excitation of the wheel.

In one embodiment, each of said flexible members is rigidly mounted into separate one or more of said pockets, where no more than one flexible member is mounted to each pocket.

In one embodiment said one or more pockets are substantially deeper than the height of their openings. The rigid mounting in the pockets may be done as an example via bonding, clamping, bolting, press-fitting or any combination thereof.

In one embodiment, said two legged fork and/or said wheel structure beams are hollow rigid structures and one or more out of said at least two flexible members pass through an openings on one or more out of said hollow rigid structures and extend into said hollow rigid structures all the way to the opposite wall inside the respective hollow structure where they are rigidly mounted into said one or more pockets.

In one embodiment, said one or more pockets are a seamless integrated part of the surrounding rigid structure of said two legged fork and said wheel structure beams. An example of this is when said one or more pockets made of fiber reinforced resin in a fiber reinforced resin structure are cured as a part of its surrounding structure in the same process as its surrounding structure. Another example is when said one or more pockets are machined into the structure by methods such as milling, or in the case of a metal structure said one or more pockets are welded onto their surrounding metal structure and/or machined into the surrounding metal structure by methods such as milling or EDM (Electrical Discharge Machining) or made in the same process by e.g. casting or forging.

Thus, making for lightweight and rigid pockets without the added weight and potential lack of connection rigidity of pockets that are not a seamless integrated part of the surrounding structure but attached to the structure.

In one embodiment, said one or more pockets are made of resin impregnated fibers where the said pockets have fibers running up or down from the pockets and out to surrounding structure, when the rotational axis of the suspended wheel is parallel to the ground and front and rear wheels of said vehicle both in contact with ground.

Thus, providing substantial rigidity and strength towards forces in the intended suspension direction of the system.

In one embodiment, said one or more pockets are made of resin impregnated fibers where the said pockets have fibers running laterally from the pockets and out to surrounding structure, when the rotational axis of the suspended wheel is parallel to the ground and front and rear wheels of said vehicle both in contact with ground.

Thus, providing rigidity and strength towards forces other than those in the intended direction of the suspension (e.g. lateral forces encountered during e.g. aggressive riding of a bicycle through a turn) to a greater extent than fibers that run up/down from said pockets and out to surrounding structure do.

In one embodiment, one or more out of said at least two flexible members pass through openings on said hollow rigid structures and extend into said hollow rigid structures all the way to the opposite wall inside the respective hollow structure where they are rigidly mounted into said one or more pockets in one or more inserts rigidly mounted to the corresponding hollow structure. Said one or more rigid inserts can for example be rigidly connected to its surrounding structure by bolts and nuts, bolts and threads in said structure or in said rigid insert, press fit or gluing.

In one embodiment, two or more out of said at least two flexible members comprise three or more flexible members and where two or more out of said three or more flexible members are separately rigidly mounted into two or more spaced apart pockets above one another in a rigid structure of said two legged fork and/or said wheel structure beams, where the distance between the most proximate points of two adjacent pockets of the said two or more tightly spaced pockets is between 1 mm and 30 mm, such as 2-10 mm.

In one embodiment, at least two flexible members are mutually rigidly mounted into a single pocket in said two legged fork and said wheel structure beams and where the at least two flexible members are spaced apart from one another in each of said pockets by means of spacer means contained within said pockets. Said mounting may be done by methods such as bonding, clamping, bolting, press-fitting or any combination thereof. Said two or more flexible members may be spaced apart from one another by a distance between, but not limited to, 0.5 mm to 25 mm, such as 0.5-10 mm, using one or more spacer means made of e.g. metallic or composite material contained within said pocket.

In one embodiment, said spacer means can be, but are not limited to being, blocks having dimensions such that one side of the blocks substantially matches the width of a mounted flexible member, the second side substantially matches the depth of said pocket and the third side is defined by the following equation (when two or more flexible members are mounted into one pocket):

(third side length)*(n−1)=hp−n*hf−2*n*gc,

where hp stands for height of said pocket, n stands for number of flexible members attached into said pocket, hf stands for thickness of flexible members and gc stands for glue clearance where gc is between 0.05 mm to 4 mm, such as 0.1-2 mm and hf is between 1 to 4 mm, such as 1.2-2.6 mm.

In one embodiment, said one or more pockets have a draft angle of between 0 and 3 degrees, so that said pockets are never substantially wider at the bottom than at the opening. Thus, enabling an internally molded (i.e. where a mold fills a pocket during the molding process) pocket to be released from its mold, yet the draft is low enough so that a gluing of a said flexible member into the pocket will function properly.

In one embodiment, said one or more pockets each include one or more extrusions measuring between 0.05 mm to 4 mm, such as 0.1-2 mm in height. Said extrusions protrude into the said one or more pockets from the top and/or bottom surfaces.

Thus, guiding one or more out of said at least two flexible members into said one or more pockets each, providing a more snug fit to the one or more out of said at least two flexible members than the rest of the corresponding pocket does. Thus, the thickness of an eventual gluing of said at least two flexible members into said one or more pockets may be controlled so as to ensure that glue does not get scraped from key bonding surfaces during insertion of one or more out of said at least two flexible members into said one or more pockets each.

In one embodiment, one or more out of said at least two flexible members each include one or more extrusions measuring between 0.05 mm to 4 mm, such as 0.1-2 mm in height. Said extrusions sticking out from the lower and/or upper surfaces of one or more out of said at least two flexible members. Said extrusions extending perpendicular to said one or more out of said at least two flexible members' width and length. Said extrusions being located on said one or more out of said at least two flexible members so that they get partially or fully submerged into said one or more pockets.

Thus, guiding one or more out of said at least two flexible members into said one or more pockets each, providing a more snug fit to the one or more out of said at least two flexible members than the rest of the corresponding pocket does. Thus, the thickness of an eventual gluing of said at least two flexible members into said one or more pockets may be controlled so as to ensure that glue does not get scraped from key bonding surfaces during insertion of one or more out of said at least two flexible members into said one or more pockets each.

In one embodiment, said extrusions are separate parts and are adapted to be inserted into said one or more pockets during or prior to the bonding process between said flexible members and said pockets.

Thus, guiding one or more out of said at least two flexible members into said one or more pockets each, providing a more snug fit to the one or more out of said at least two flexible members than the corresponding pocket otherwise does. Thus, the thickness of an eventual gluing of said at least two flexible members into said one or more pockets may be controlled so as to ensure that glue does not get scraped from key bonding surfaces during insertion of one or more out of said at least two flexible members into said one or more pockets each.

In one embodiment, said vehicle suspension system comprises one or more resilient members attached to either said frame structure or wheel structure at a position so that it is squeezed between the frame structure and wheel structure in rest position or when e.g. said wheel structure is pulled downwards relatively to said frame structure by up to 30 mm, when the rotational axis of the suspended wheel is parallel to the ground and front and rear wheels of said vehicle are horizontal to one another. Thus, excessive rebound of the suspension system may be prevented.

In one embodiment, said vehicle suspension system comprises one or more resilient members attached to one or more of the following three options; said frame structure, said wheel structure or one or more out of said at least two flexible members. Said resilient member is at a position so that it is squeezed between the frame structure or wheel structure and the said one or more out of said at least two flexible members in rest position or when e.g. said wheel structure is pulled downwards by up to 30 mm relatively to said frame structure, when the rotational axis of the suspended wheel is parallel to the ground and front and rear wheels of said vehicle are horizontal to one another. Thus, excessive rebound of the suspension system may be prevented.

In one embodiment, said vehicle suspension system comprises one or more strings/straps connected between the wheel structure and the frame structure, said strings/straps having such lengths and being connected at positions so that they are tensioned in rest position or when said wheel structure is pulled downwards by up to 30 mm relatively to said frame structure and said strings/straps developing more slack when said wheel structure is pulled upwards relative to said frame structure, when the rotational axis of the suspended wheel is parallel to the ground and front and rear wheels of said vehicle are horizontal to one another. Thus, excessive rebound of the suspension system may be prevented.

In one embodiment, said vehicle suspension system comprises one or more resilient members, attached to either said frame structure or wheel structure. Said resilient member is at a position so that it is squeezed between the frame structure and wheel structure when said wheel structure is pulled upwards relative to said frame structure by between 10 to 120 mm, such as 20-80 mm, when the rotational axis of the suspended wheel is parallel to the ground and front and rear wheels of said vehicle are horizontal to one another. Thus, providing a bump-stop functionality of the said vehicle suspension system and protecting said at least two flexible members from excessive loads.

In one embodiment, said vehicle suspension system comprises one or more strings/straps connected between said wheel structure and frame structure, said strings/straps having such lengths and being connected at positions so that they are tensioned when said wheel structure is pulled upwards relative to said frame structure by between 10 to 120 mm, such as 20-80 mm, when the rotational axis of the suspended wheel is parallel to the ground and front and rear wheels of said vehicle are horizontal to one another. Thus, providing a bump-stop functionality of the said vehicle suspension system and protecting said at least two flexible members from excessive loads.

Said resilient member may as an example be, but is not limited to being, a polyurethane pad, rubber pad, neoprene fabric, silicone pad or similar.

In one embodiment, said at least two flexible members are made out of a composite material such as, but not limited to, carbon-, Kevlar-, glass-, flax-, boron-, basalt-, etc. fibers in resin such as epoxy, polyester, etc.

In one embodiment, said at least two flexible members are made out of a metal such as, but not limited to, titanium or steel.

In one embodiment, one or more out of said at least two composite material flexible members are constructed from several layers of resin impregnated fiber layers. Said layers arranged in such a manner so that one or more individual layers starting at an end of said flexible member do not reach all the way towards the lengthwise center of the said flexible member but are replaced with layers with its fibers at a greater angle from the length direction of the flexible member.

Thus, the fibers at a greater angle from the length direction of the flexible member contribute less to the flexural strength and stiffness of the flexible member, but give it increased torsional rigidity. As the flexural stress on a flexible member of said suspension system rigidly attached on both ends is increasing towards the ends of the flexible member it is beneficial to emphasize flexural strength to a greater extent closer to the ends, but closer to the lengthwise center of the flexible member it is beneficial to substitute some flexural strength and stiffness for torsional rigidity. This makes for a flexible member that provides greater flex in the intended direction of the suspension while maintaining a high safety factor and torsional rigidity.

According to a second aspect, the present invention relates to a vehicle comprising said suspension system.

In one embodiment, said vehicle is selected from being:

a bike,

a bicycle,

a motorbike,

a motorized bicycle,

a scooter or

a tricycle.

Throughout this document it is assumed that the vehicle including said suspension system is resting in an upright position with both front and rear wheels parallel to the ground with the rotational axis of the wheels parallel to the ground.

Throughout this document the term structure refers to any type of structure, such as a rigid structure.
According to a third aspect, the present invention relates to a front wheel vehicle suspension assembly comprising:
a two legged fork,
   wherein the front wheel vehicle suspension assembly further comprises:
a wheel structure comprising wheel structure beams adapted to be positioned posterior to the two legged fork,
two sets of at least two spaced apart flexible members adapted to extend between the respective one of said two legs of said two legged fork and said wheel structure beams such that said two sets of flexible members are located on respective lateral sides of a suspended wheel,
   wherein each of said wheel structure beams comprises hub mounts adapted to be located above one or more out of said at least two flexible members on each side of the suspended wheel and below one or more out of said at least two flexible members on each side of the suspended wheel and such that said hub mounts are positioned opposingly to each other and are adapted to receive a connection to one another via the hub of the suspended wheel, where each of said flexible members is adapted to be mounted into attachment pockets in said two legged fork and said wheel structure beams.
   The wheel structure beams are preferably two wheel structure beams.

According to a fourth aspect, said suspension system is a rear wheel suspension system and said wheel structure is a rear wheel structure, where said at least two flexible members connect the posterior part of said frame structure to a said rear wheel structure, where the said rear wheel structure is posterior to the frame structure on both lateral sides of the rear wheel and has a posteriorly located hub mount on each side of the rear wheel structure, the sides being connected together with one or more rigid connections.

Thus, a suspension mechanism is provided on both sides of the rear wheel with a rigid connection between the sides, this significantly increases the lateral stiffness of the rear wheel suspension system.

In general the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 shows a perspective view an embodiment of a vehicle comprising vehicle suspension systems according to the present invention,

FIG. 2 shows an expanded side view of the front wheel suspension system shown in FIG. 1,

FIG. 3 shows a side view of an embodiment of a front wheel suspension system according to the present invention,

FIG. 4 depicts a perspective view of the front wheel suspension system shown in FIGS. 1 and 2,

FIG. 5 shows an embodiment of the front wheel suspension system shown in FIG. 2 where the front wheel suspension system further comprises an upwardly extending damper,

FIGS. 6-8 show different embodiment of a front wheel suspension system according to the present invention,

FIGS. 9-13 show different embodiments of a suspension system according to the present invention wherein said suspension system is a rear wheel suspension system,

FIGS. 14-23 show different embodiments of rigid connections between a flexible member and a rigid structure according to the present invention. Said rigid structure being a wheel structure or frame structure,

FIGS. 24-25 show different embodiments of the present invention where a flexible member is protected with a resilient material,

FIG. 26 shows an embodiment of the front wheel suspension system shown in FIG. 3 where the front wheel suspension system further comprises a disc brake caliper and the front wheel comprises a disc brake disc.

FIGS. 27-33 show different embodiments of pre-loading and bump-stopping the front wheel suspension system shown in FIG. 2.

FIGS. 34-36 show a full perspective view of different embodiments of a front wheel suspension system according to the present invention.

FIG. 37 describes a resilient means of receiving and distributing load from a said resilient member.

FIG. 38 shows a method of fastening said resilient member.

FIG. 39 describes the positioning of said hub mount of said suspension system.

FIGS. 40-41 describe loading scenarios of the said suspension system.

FIGS. 42-75 describe different pocket designs, methods of attaching a flexible member into a pocket and methods of constructing said pockets.

FIGS. 76-81 show different designs of said flexible members.

### DESCRIPTION OF EMBODIMENTS

In general, and as will be discussed in more details later, the present invention relates to a vehicle suspension system comprising at least two flexible members arranged in a non-planar way with a distance there between, where the at least two flexible members are rigidly mounted between a frame structure of a vehicle and a wheel structure of said vehicle, the arrangement of said flexible members being such that a guided suspension is provided that is resistive against forces other than those in the intended direction of the suspension movement. In particular, the present invention relates to a suspension system for a vehicle where the travel of the suspension follows a curved path, where by altering the configuration of the system different travel paths are achieved, depending on desired response to excitation forces. These flexible members can provide suspension without supplementary means of suspension guiding, i.e. sliding surfaces and/or links and pivots, which is reflected in less maintenance and better response to excitation. Also, the weight of additional components such as telescopic arms and/or links and pivots is eliminated.

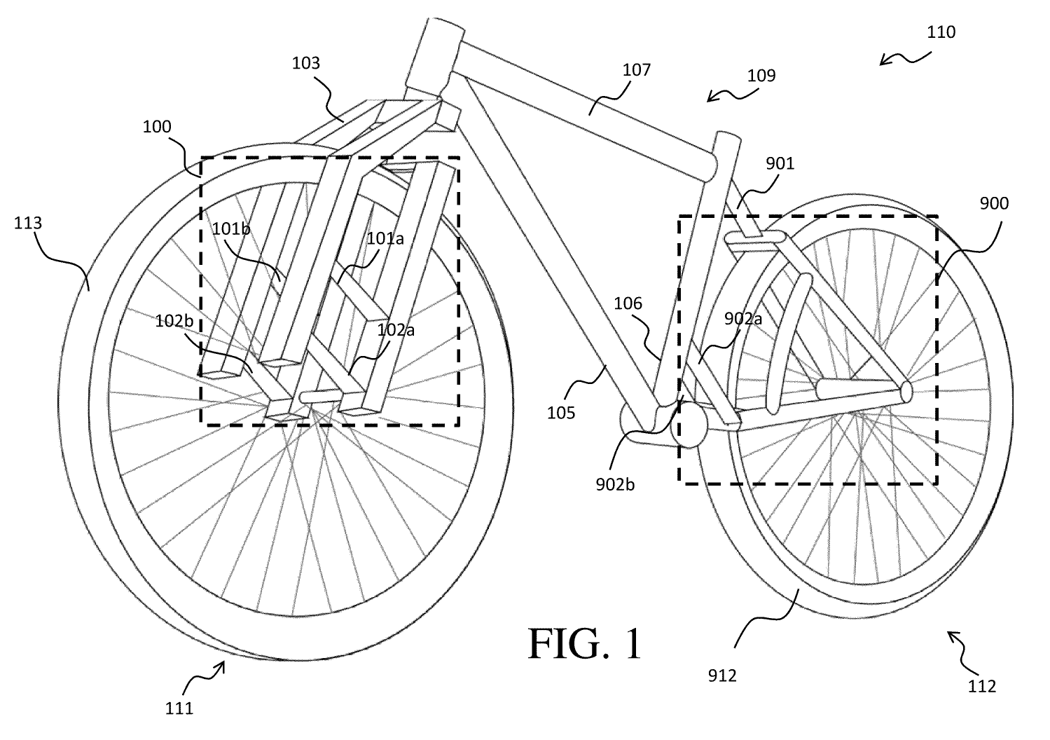

FIG. 1 shows a perspective view of an embodiment of a vehicle 110 comprising vehicle suspension systems 100, 900 according to the present invention. The vehicle 110 may be selected from, but is not limited to, a bike, a bicycle, motorized bicycle, a motorbike, a scooter or a tricycle. As depicted here, the vehicle comprises a frame structure 109 including a top tube 107, a seat tube 106, a down tube 105, a two legged bike fork 103 and a front wheel structure 111 and a rear wheel structure 112.

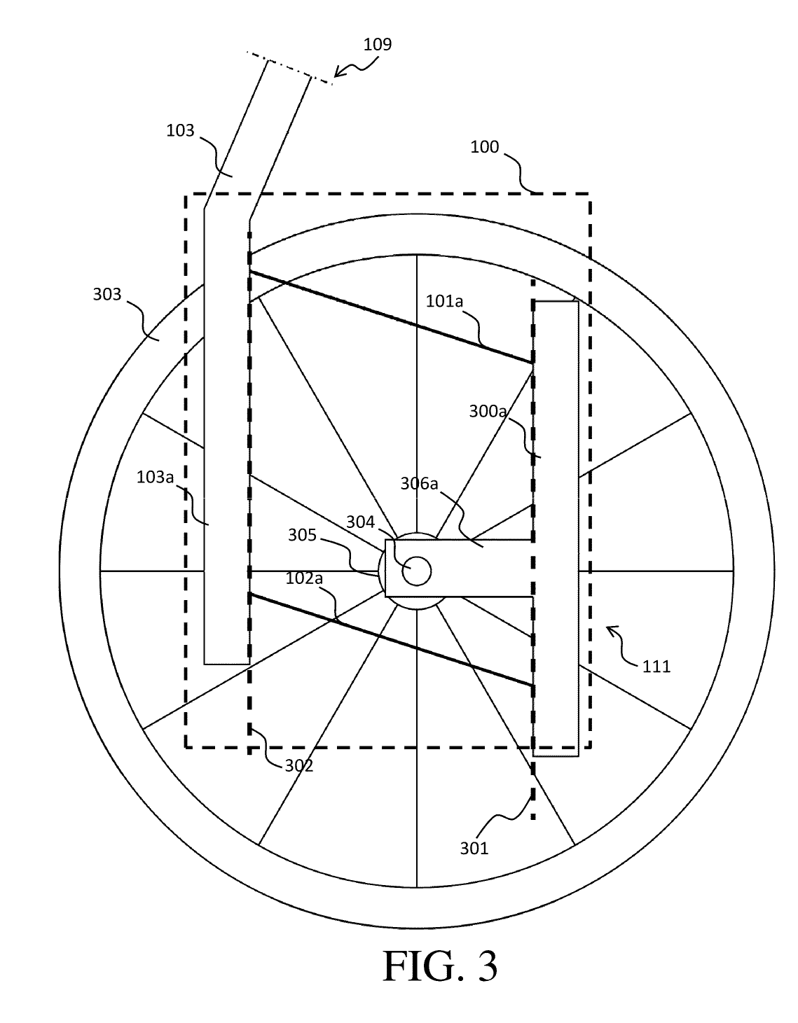

In the embodiment shown here the vehicle 110 is a bicycle including both a front and rear wheel suspension systems 100, 900, but the bicycle could just as well include only a front wheel suspension system 100 or only a rear wheel suspension system 900. The front and rear wheel suspension systems 100, 900 shown here comprise, respectively, two flexible members 101a,b, 102a,b, 901, 902a,b arranged in a non-planar way with a distance there between that are rigidly mounted between the frame structure 109 of the bicycle 110 and the front and rear wheel structures 111, 112, respectively. As depicted here the frame structure 109 includes a two legged fork 103 where the rigid mounting to the frame structure is to the two legged fork. This will be discussed in more details in relation to FIG. 3. The arrangement of the flexible members 101a,b, 102a,b, 901, 902a,b is such that the suspension system provides guided suspension and is resistive against forces other than those in the intended direction of the suspension movement.

The hub mounts of the front wheel suspension system 100 is positioned between the flexible members 101a, 1021 (see e.g. FIG. 3). Also, FIG. 1 should, as shown here, not be limited to only one flexible member above the hub mounts and only one flexible member below the hub mounts, but there may just as well be two or more flexible members place above the hub mounts and two or more flexible members placed below the hub mounts, where the two or more flexible members above and below the hub mounds may be closely spaced together.

The flexible members may be made of any kind of material that has high flexibility, high flexural strength, good fatigue properties and low weight, such as various composite materials, for example; carbon fiber, glass fiber, basalt fiber, flax fiber, boron fiber or aramid fiber, or metals, for example various titanium alloys.

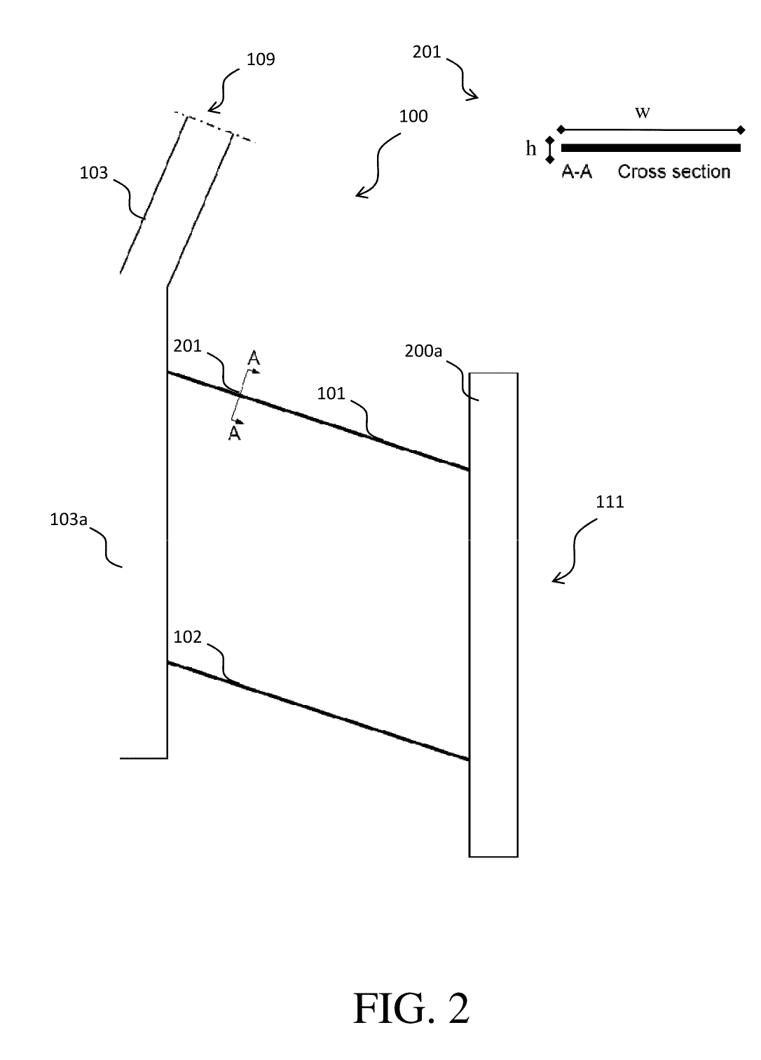

FIG. 2 shows an illustrative side view of a front wheel suspension system 100 according to the present invention. Shown is also a zoomed up view 201 of the cross section of a flexible members 101, 102, where the shape of the cross section is substantially rectangular and the dimension of the cross section is such that the width (w) is several times greater than its height (h) and forms a thin plate structure, and where the width is substantially parallel to ground when the front wheel suspension system 100 is in a vertical position in relation to the ground.

As depicted here, the two flexible members 101, 102 are parallel, of substantially equal length and rigidly mounted to the two opposite beams 103a, 200a at each lateral sides of the front wheel (see FIG. 1), one beam being a leg 103a of the bike fork 103 belonging to the frame structure 109 and the other one being a wheel structure beam 200a belonging to the wheel structure 111.

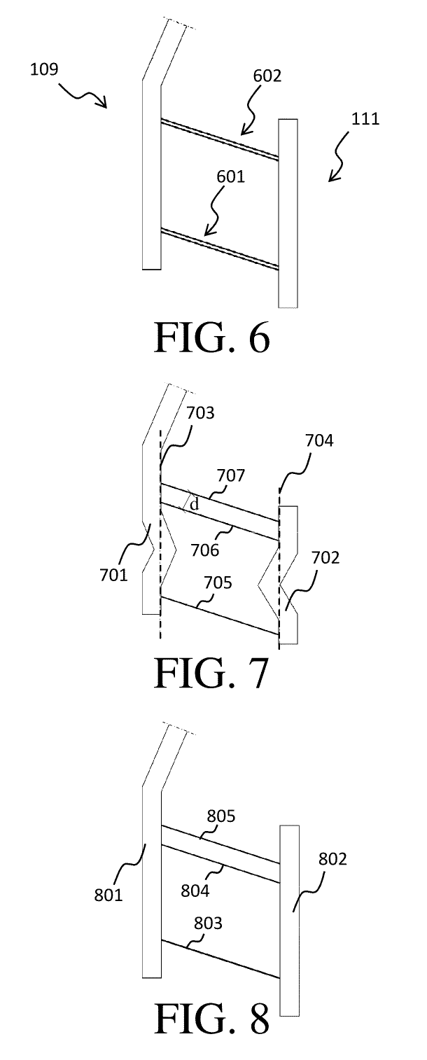

FIG. 3 shows a side view of an embodiment of a front wheel suspension system 100 according to the present invention, where the front wheel structure 111 includes wheel structure beam 300a positioned posterior to the two legged bike fork 103 on both lateral sides of the front wheel 303 and has an anteriorly located hub mount 304 on each side of the wheel 303 connected together with one or more rigid connections, where the hub mount 304 can serve as one rigid connection. The rigid connections may be e.g. a piece of metal or composite material rod and the like extending through the hub 305 of the wheel 303. The posteriorly located wheel structure beam 300a shown here has a lateral protruding portion 306a that is rigidly connected to the hub mount 304 and a vertical portion 300a. As will be discussed in more details in relations to FIGS. 6-8 the shape of the wheel structure 111 as well as the shape of the fork legs 103a,b should not be construed as being limited to the geometrical forms shown here.

In this embodiment the two flexible members 101a, 102a, but they just be two or more above the hub mount 304 and below the hub mount 304, are arranged in a substantially parallel way when the front wheel suspension system 100 is in a rest position to ensure that the stresses in the flexible members are distributed optimally. Also, the rigid connections between the two flexible members 101a, 102a and the two legs 103a of the fork 103, belonging to the frame structure 109, are substantially co-planar in the plane 302 on both lateral sides of the front wheel 303. In the same way, the two flexible members 101a, 102a are rigidly connected to the posteriorly located wheel structure beam 300a substantially co-planar in the plane 301. These two planes 301, 302 are preferably parallel when the front wheel suspension system 100 is in a rest position. Further, as shown here, it is preferred that the two (or more) flexible members 101a, 102a extend, in relation to the wheel structure 111, in an upwards direction from the wheel structure 111 and towards the frame structure 109.

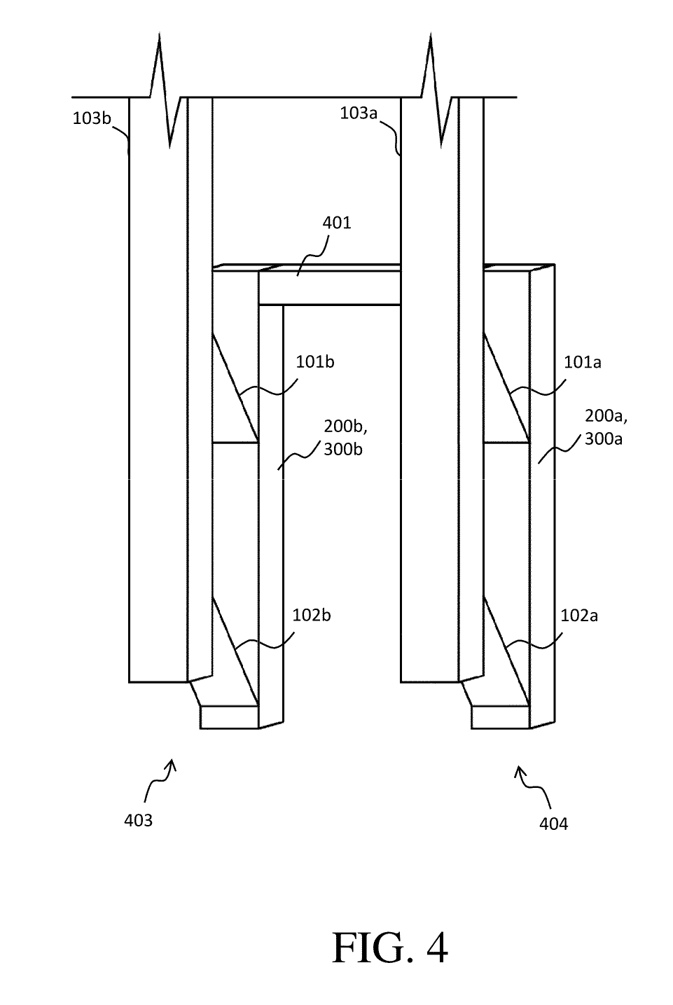

FIG. 4 depicts a perspective view of a variation of the front wheel suspension system 100 shown in FIGS. 2 and 3 showing the two lateral sides 403, 404 to the front wheel 203 (not shown), with said two upwardly extending bicycle (vehicle) fork legs 103a, 103b and said upwardly extending wheel structure beams 200a,b, 300a,b (the laterally protruding structure 306 from FIG. 3 is non-existing in this embodiment and the hub mounts are not shown). Shown are also the flexible members 101a,b, 102a,b rigidly mounted there between. This embodiment further comprises a rigid member 401 that may be positioned above the front wheel for rigidly mounting the upwardly extending wheel structure beams 200a,b, 300a,b together.

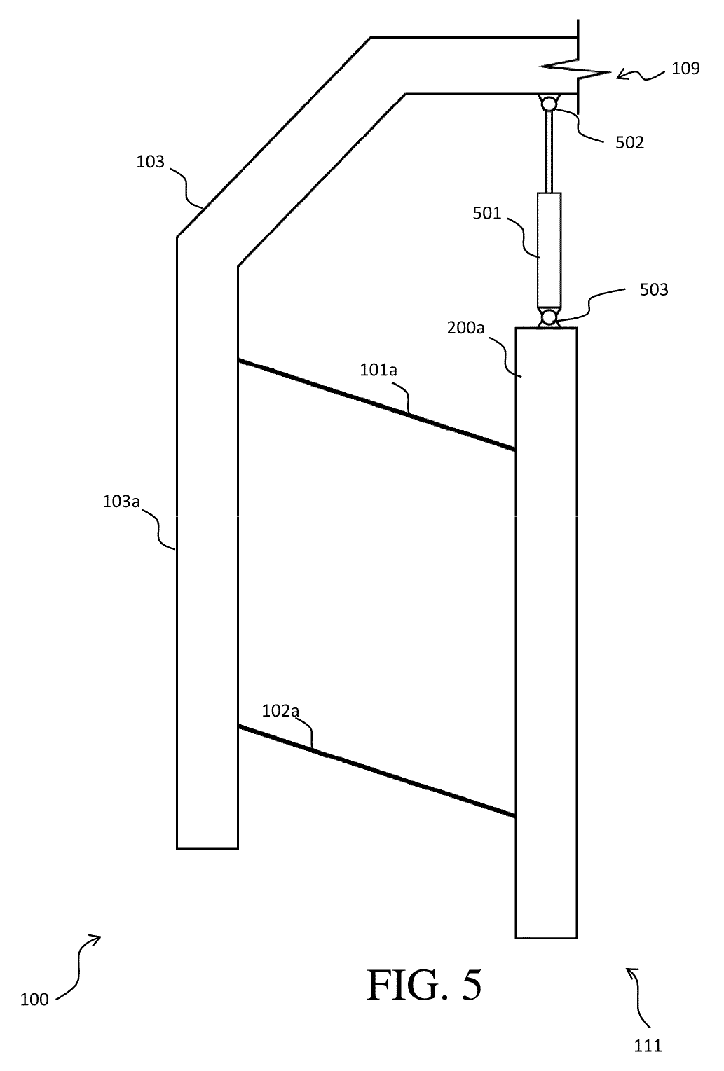

FIG. 5 shows an embodiment of the front wheel suspension systems 100 shown in FIG. 2 where the front wheel suspension systems 100 further comprises an upwardly extending damper 501 arranged from the wheel structure beam 200a to the frame structure 109. As shown here, the damper 501 comprises pivots 502, 503 on each end. The damper 501 is mounted between the wheel structure beam 200a and the frame structure 109 of the bicycle in substantially vertical way. By arranging such a damper 501 there between a further control of the dynamics of the suspension is provided since compression and rebound energy can now be absorbed. This arrangement also provides an option of a lock-out function of the suspension system. The placement of the damper should not be construed as being limited to the geometrical forms shown here.

FIGS. 6-8 show different embodiments of a front wheel suspension system 100 according to the present invention. In FIG. 6, the at least two flexible members form bundles 601, 602 of closely spaced flexible members at the opposite ends of the wheel structure 111 and frame structure 109 where the number of flexible members within each bundle is two or more and where the flexible members within each bundle are preferably parallel.

FIG. 7 shows an embodiment where the wheel structure beam 702 and the leg 701 of the fork are V-shaped and where the number of flexible members is three, one 705 extending from the bottom of the wheel structure beam 702 upward and towards the fork leg 701, a second and third flexible members 706, 707 situated at the opposite end where the internal arrangement between the second and third flexible members 706, 707 is such that there is a pre-determined distance d between them which can be few millimeters up to several centimeters. The flexible members 705-707 are rigidly mounted to the fork leg 701 and the wheel structure beam 702 in a parallel way. The dotted lines 703, 704 indicate that the connections between the flexible members and the frame structure 701 are in a plane parallel to a plane running through the connections between said flexible members and wheel structure 702.

FIG. 8 shows the embodiment from FIG. 7 with three flexible members 803, 804, 805 two of which being positioned at the upper end of the front wheel suspension system and one flexible member 803 being positioned at the opposite end, but where the wheel structure beam 802 and the fork leg 801 are straight elongated beams.

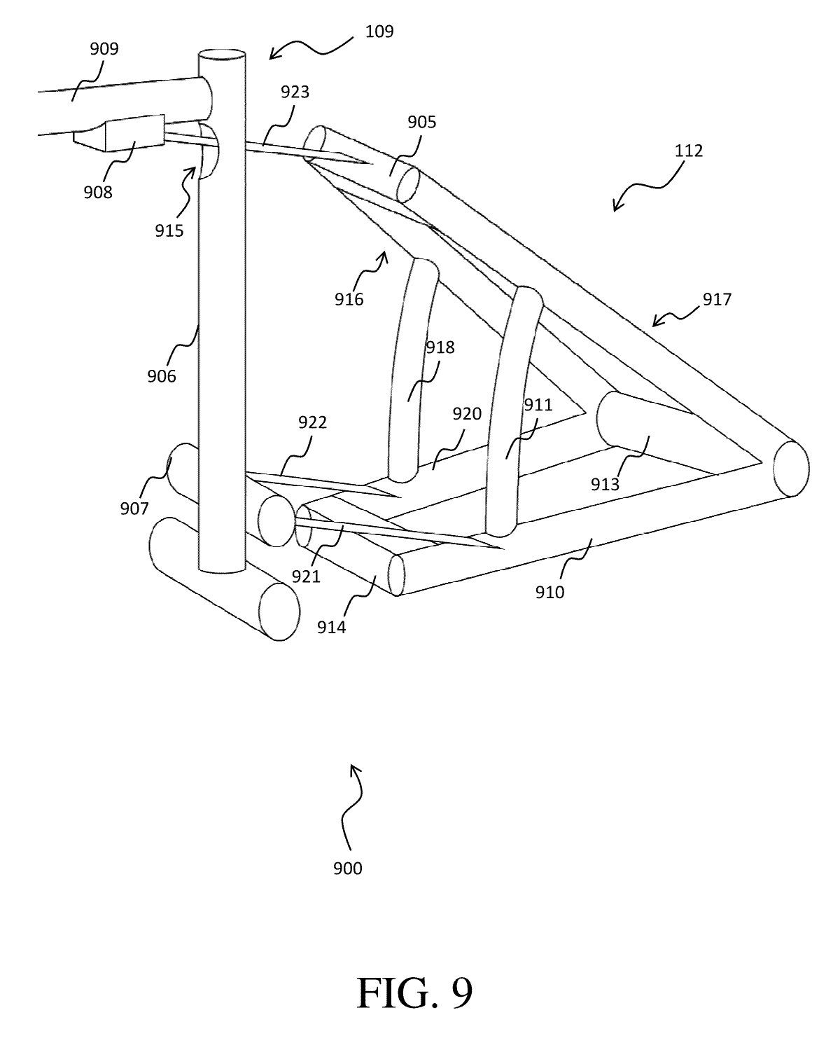

FIG. 9 shows one embodiment of a suspension system 900 according to the present invention wherein the suspension system is a rear wheel suspension system and the wheel structure is a rear wheel structure 112. The frame structure 109 in this embodiment comprises a support means 907 rigidly mounted to the lower section of the seat tube 906 facing the rear wheel structure 112 and support means 908 mounted to the top tube 909 of the frame structure. The rear wheel structure 112 comprises two V-shaped structures 916, 917 rigidly mounted together via rigid members 905, 913, 911, 918, 914. The hub mount is a horizontal beam 913 that at the same time acts as a further support for rigidly mounting the V-shaped structures together. There are three flexible members 921, 922, 923 that connect the posterior part of the frame structure 109 to the anterior part of the rear wheel structure 112, two flexible members 921, 922 that are in-plane and extend from the chainstays 910, 920 upward and towards said support means 907 mounted to the seat tube 906. The third flexible member 923 extends between said horizontal beam 905 upwards and towards said support means 908 mounted to the top tube 909 of the frame structure 109 via a hole 915 in the seat tube 906.

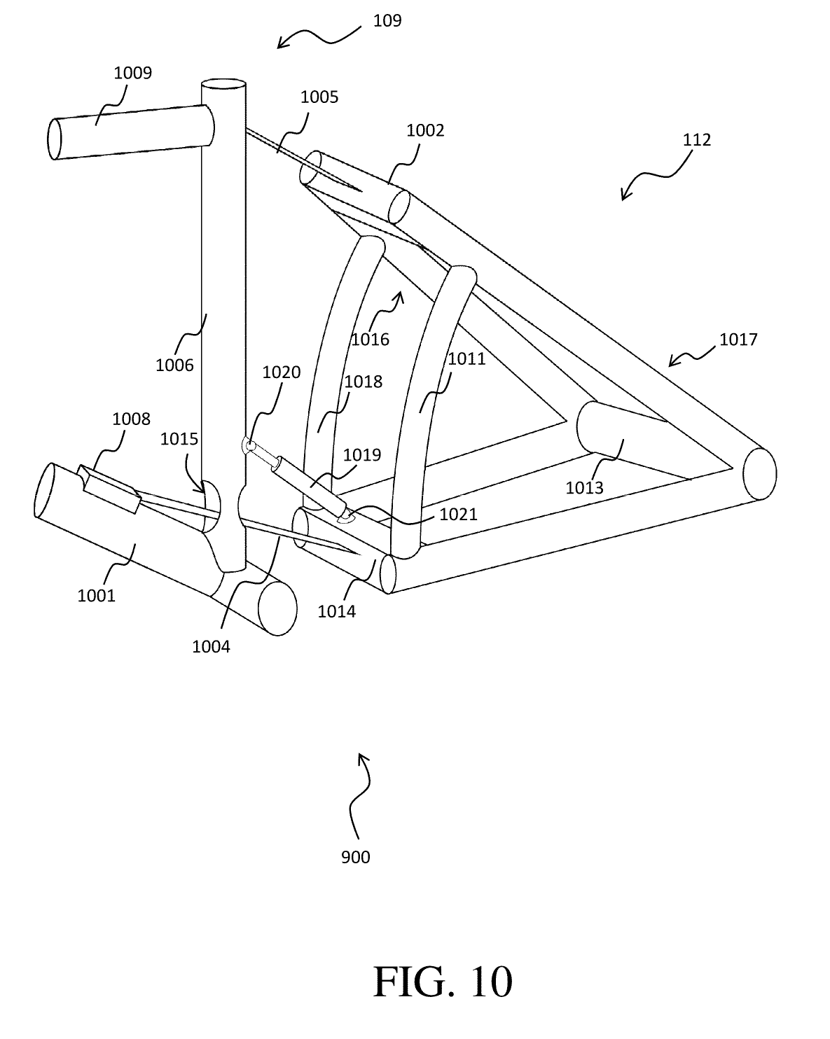

FIG. 10 shows another embodiment of a rear wheel suspension system 900 according to the present invention. The frame structure 109 in this embodiment comprises a seat tube 1006, a top tube 1009, a down tube 1001 facing the rear wheel structure 112 and support means 1008 mounted to the down tube 1002 of the wheel structure. Similar as discussed in relation to FIG. 9 the rear wheel structure 112 comprises two V-shaped structures 1016, 1017 rigidly mounted together via rigid members 1013, 1011, 1018, 1014, 1002. As shown here, the arc-shaped rigid members 1011, 1018 compared to the ones shown in FIG. 9, 911, 918, are positioned at the distal ends of the of V-shaped structures 1016, 1017. The hub mount in this embodiment is the horizontal beam 1013 that simultaneously is used to rigidly mounting the two V-shaped structures 1016, 1017 together. The two flexible members 1004, 1005 that connect the posterior part of the frame structure 109 to the anterior part of the rear wheel structure 112 extend from the two horizontal beams 1002, 1014 upwards and towards the upper end of the seat tube 1006 and via a hole 1015 in the seat tube towards the support means 1008, respectively. This embodiment further comprises an upwardly extending damper 1019 between the frame structure 109 and the wheel structure 112, connected to respective sides by pivots 1020, 1021, further controlling the dynamics of the suspension by means of absorbing compression and rebound energy where desired and a lock-out function possibility of the suspension is provided.

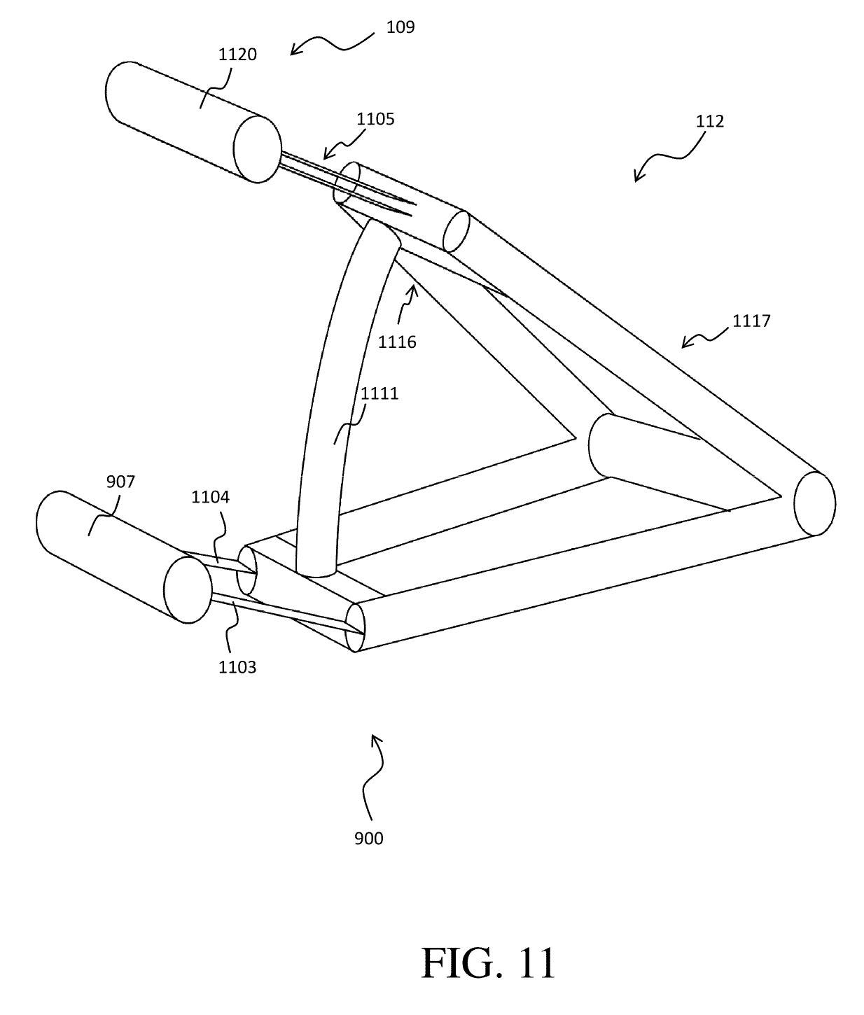

FIG. 11 shows another variation of the embodiment shown in FIG. 9 where the arc-shaped rigid members 1011, 1018 from FIG. 10 are replaced with a single rigid member 1111 positioned at the distal end of the of V-shaped structures 1116, 1117 and where a bundle of two or more tightly stacked flexible members 1105 provides the connection between the upper part of the rear wheel structure 112 to a support means 1120 rigidly mounted to the frame structure 109.

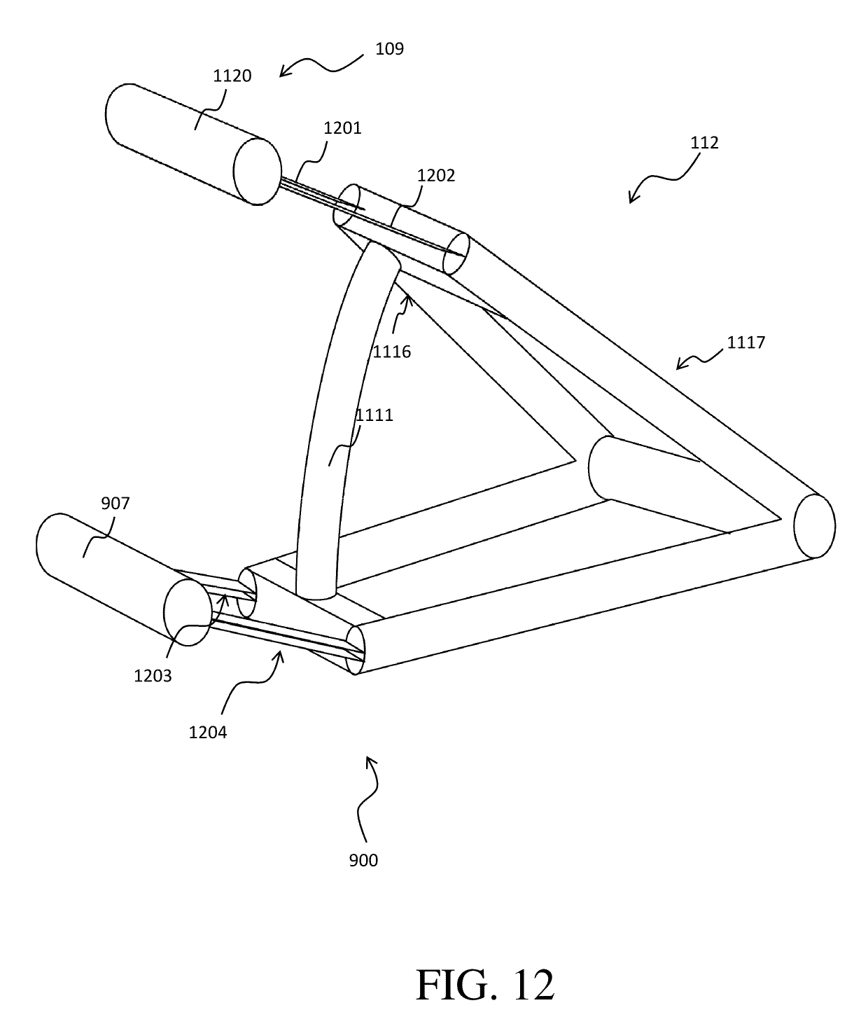

FIG. 12 shows a variation of the embodiment shown in FIG. 11, comprising two laterally spaced flexible members 1201, 1202 providing the connection between the upper part of the rear wheel structure 112 and the upper part of the frame structure 109 and comprising two laterally spaced bundles of two or more tightly stacked flexible members 1203, 1204 providing the connection between the lower part of the rear wheel structure 112 and the lower part of the frame structure 109.

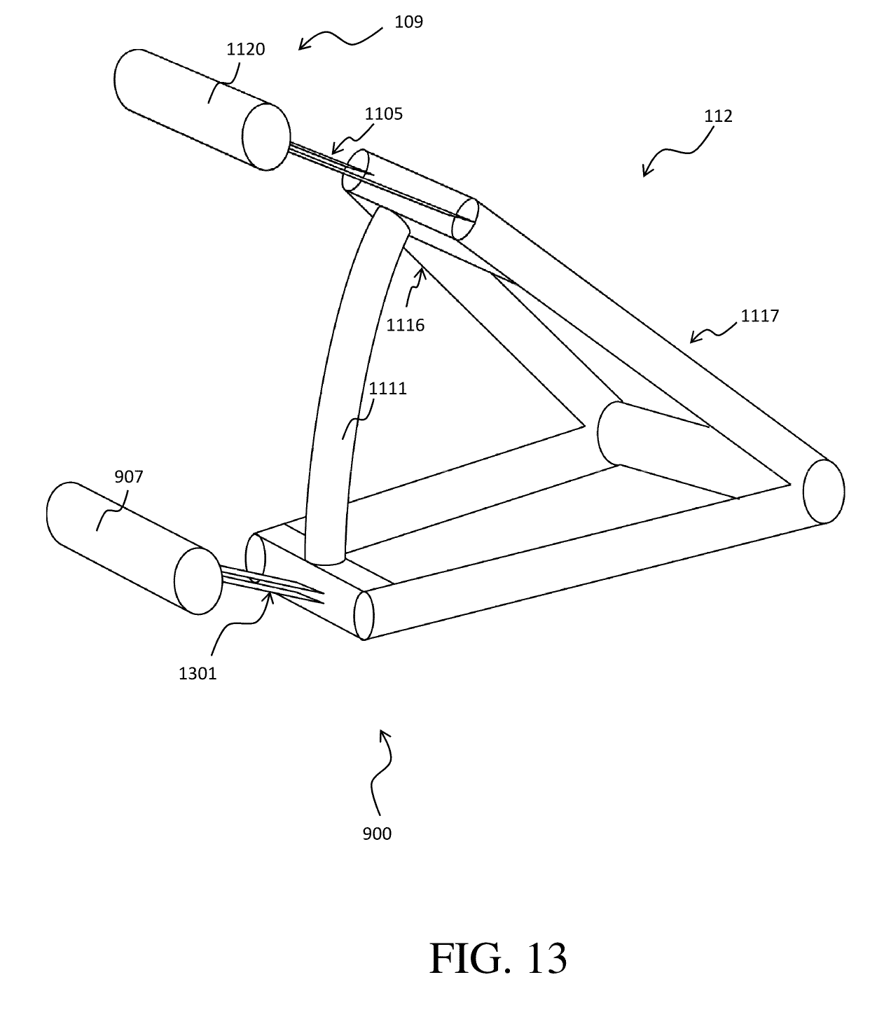

FIG. 13 shows another variation of the embodiment shown in FIG. 12, comprising a single bundle of two or more tightly stacked flexible members 1301 providing the connection between the lower part of the rear wheel structure 112 and the lower part of the frame structure 109.

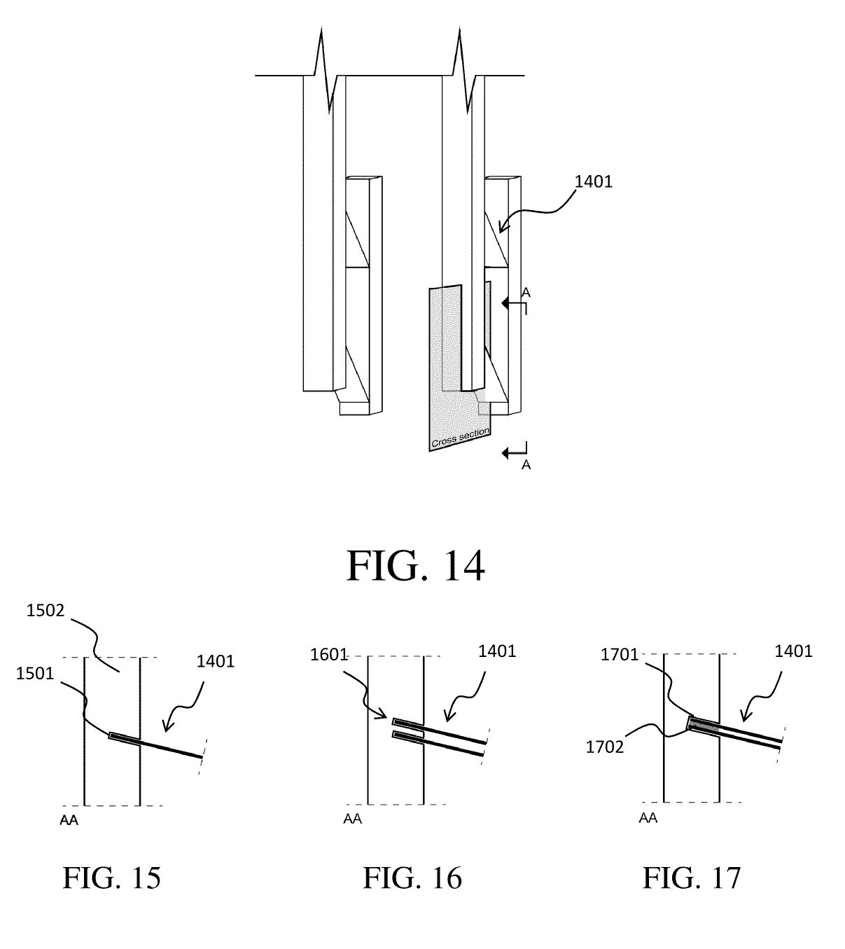

FIG. 14 shows a section cut A-A of a perspective view of the front wheel suspension system 100 (hub mounts not shown here), a part of this section cut is examined in detail in

FIGS. 15-17 providing a view of different embodiments of rigidly mounting a flexible member or a bundle of flexible members 1401 of the present invention to a wheel structure or frame structure.

FIG. 15 shows an embodiment of the invention where one or more of said two or more flexible members 1401 are rigidly separately mounted into pockets 1501 in a rigid structure 1502, said rigid structure being a front wheel structure 111, rear wheel structure 112 or a frame structure 109. Said pockets being substantially deeper than the height of their opening. Said one or more flexible members are rigidly mounted by methods such as bonding, clamping, bolting or press-fitting.

FIG. 16 shows a variation of the embodiment in FIG. 15 where two or more of said two or more flexible members 1401 are rigidly mounted into tightly spaced pockets 1601 in said rigid structure. Said pockets being substantially deeper than the height of their opening.

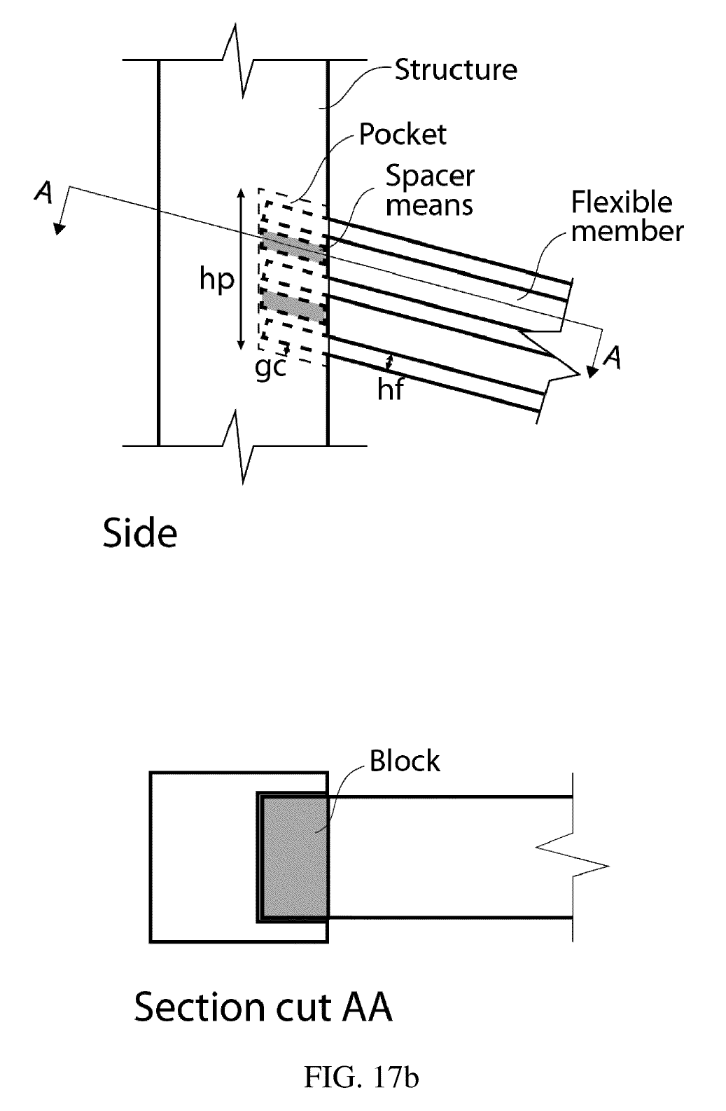

FIG. 17 shows a variation of the embodiment in FIG. 15 where two or more out of said two or more flexible members 1401 are spaced apart from one another by e.g. metallic or composite material spacer means 1702 contained within a pocket and mutually rigidly mounted into a single pocket 1701 in said rigid structure.

FIG. 17b further describes dimensions of the embodiment from FIG. 17 where said spacer means can be, but are not limited to being, blocks having dimensions such that one side of the blocks substantially matches the width of a mounted flexible member, the second side substantially matches the depth of said pocket and the third side is defined by the following equation (when two or more flexible members are mounted into one pocket):

(third side length)*(n−1)=hp−n*hf−2*n*gc,

where hp stands for height of said pocket, n stands for number of flexible members attached into said pocket (in this figure n=3), hf stands for thickness of flexible members and gc stands for glue clearance where gc is between 0.05 mm to 4 mm, such as 0.1-2 mm and hf is between 1 to 4 mm, such as 1.2-2.6 mm.

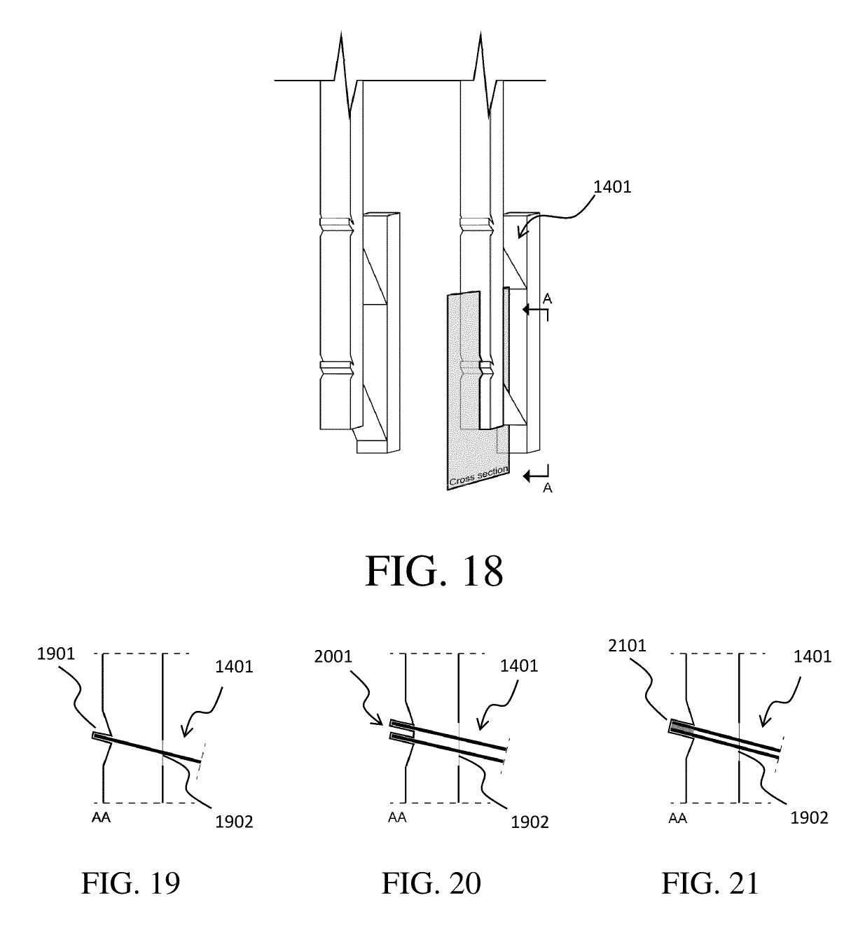

FIGS. 18-21 show variations of the embodiments shown in FIGS. 14-17 where said one or more of said two or more flexible members 1401 pass through a hole 1902 on one side of a hollow wheel structure or hollow frame structure and are rigidly mounted to a pocket 1901, 2001, 2101 on the opposite wall of the respective hollow structure.

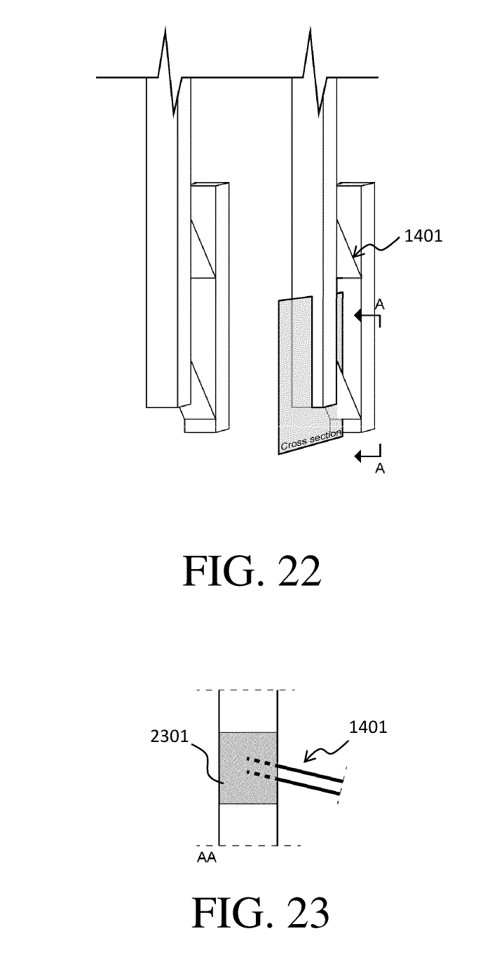

FIGS. 22-23 shows a variation of the embodiments shown in FIGS. 14-21 where said one or more out of at least two flexible members 1401 pass through a hole on one side of a hollow wheel structure or hollow frame structure and are rigidly mounted into a rigid insert 2301 rigidly mounted to the corresponding structure.

In one variation of the embodiments shown in FIGS. 14-21 the depth of said one or more pockets is between 5 mm and 20 mm, such as 8-15 mm.

In one variation of the embodiments shown in FIGS. 14-21 the height of said one or more pockets at its opening is between 1 mm and 5 mm, such as 2-4 mm.

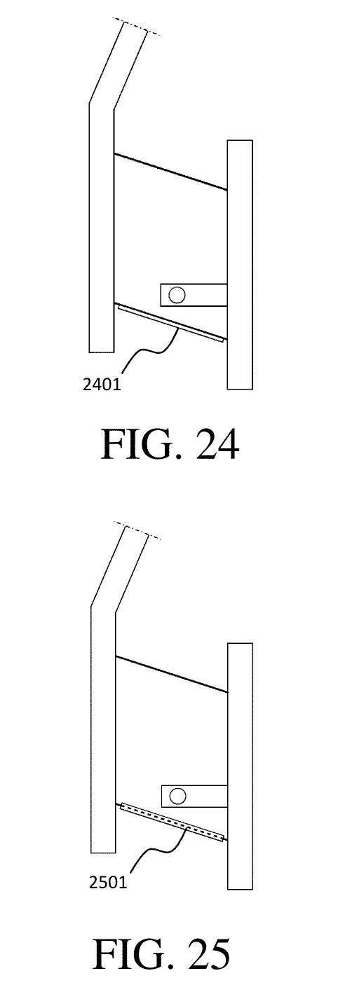

FIG. 24 and FIG. 25 show embodiments of the invention where one or more of said two or more flexible members is covered, either partially or fully, with a resilient protective material 2401, 2501.

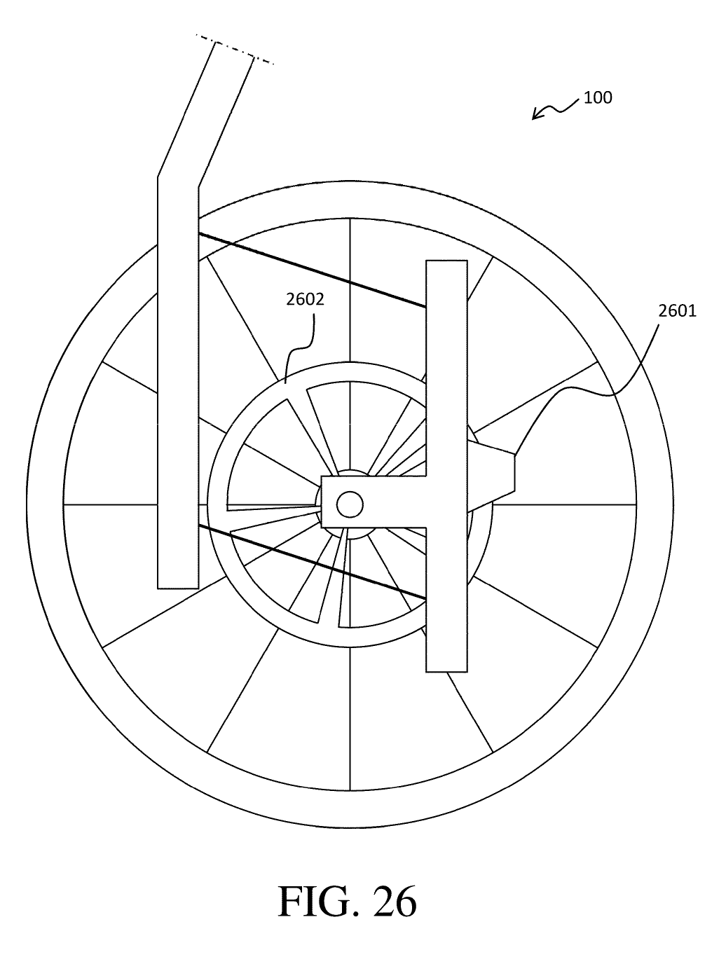

FIG. 26 shows an embodiment of the front wheel suspension system 100 from FIG. 3 where a disc-brake caliper 2601 is rigidly mounted to the wheel structure and the wheel comprises a disc-brake disc 2602.

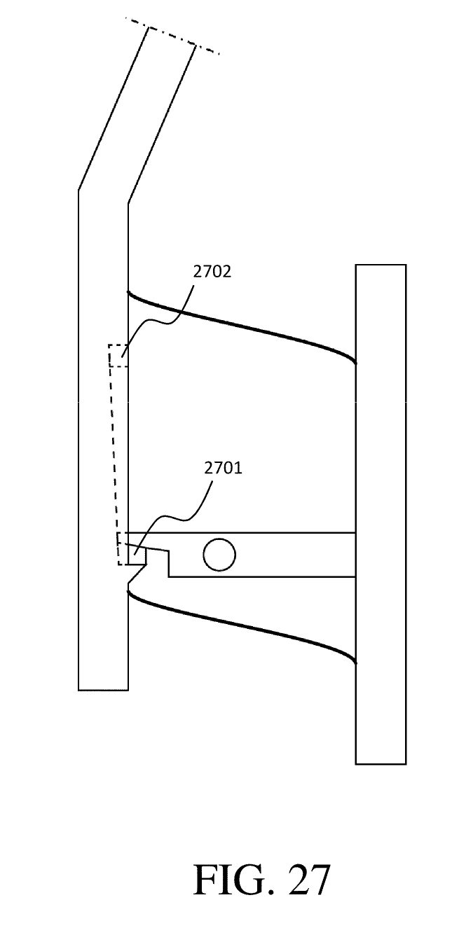

FIG. 27 shows an embodiment of the front wheel suspension system 100 from FIG. 3 where the said two or more flexible members are pre-loaded mechanically by a resilient member 2701, attached to either frame structure or wheel structure, squeezed between the frame structure and wheel structure in rest position, preventing the suspension system from excessive suspension rebound. Furthermore a secondary resilient pad 2702 provides bump-stop functionality for the mechanism and prevents the said two or more flexible members from mechanical failure under extreme loads. In this figure the said resilient members are located in a recess into the said two legged fork of said front wheel suspension system.

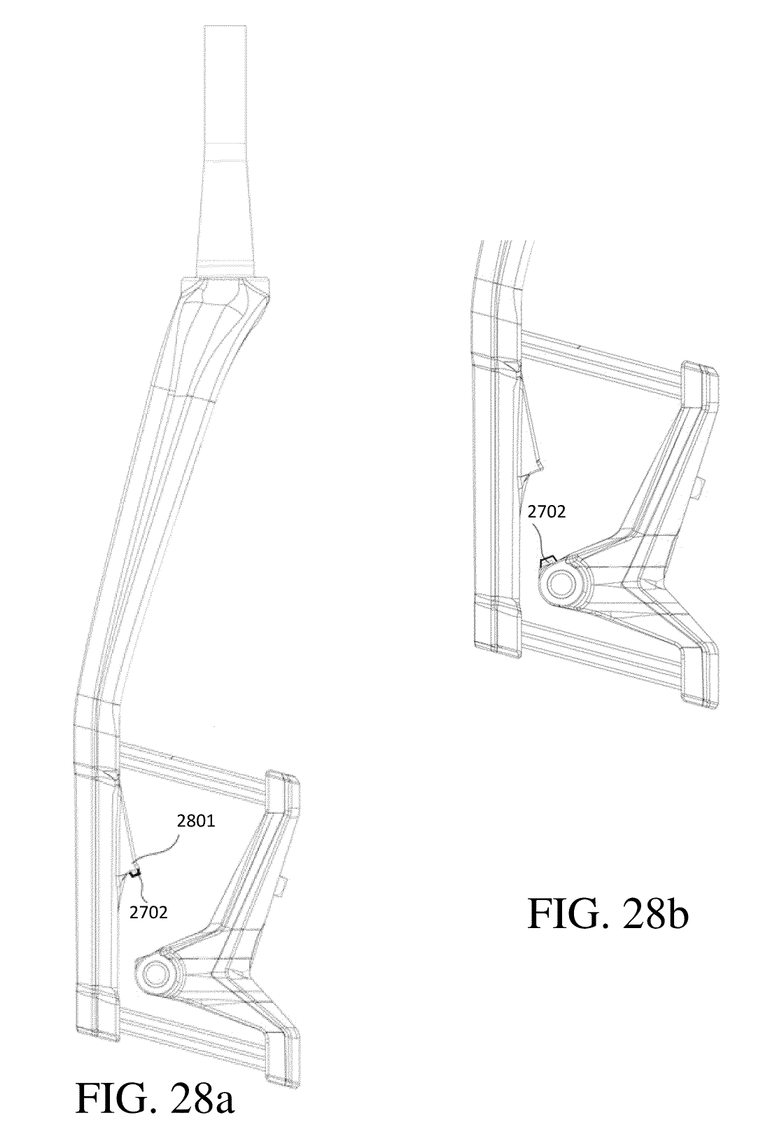

FIG. 28a shows a variation of the embodiment in FIG. 27 where the said bump stop resilient pad 2702 is not located in a recess, but on a hump 2802 on the said two legged fork.

FIG. 28b shows a variation of the embodiment in FIGS. 27-28a where said bump stop resilient pad 2702 is located on said wheel structure beams.

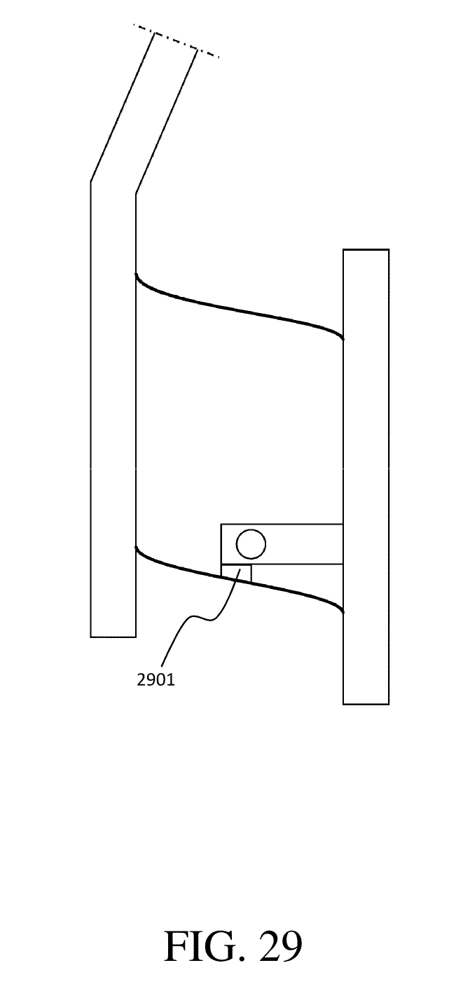

FIG. 29 shows a variation of the pre-loading method from FIG. 28, here the resilient pad 2901, attached to either one or more of said flexible members or wheel structure, is squeezed between the wheel structure and one or more of said flexible members in rest position.

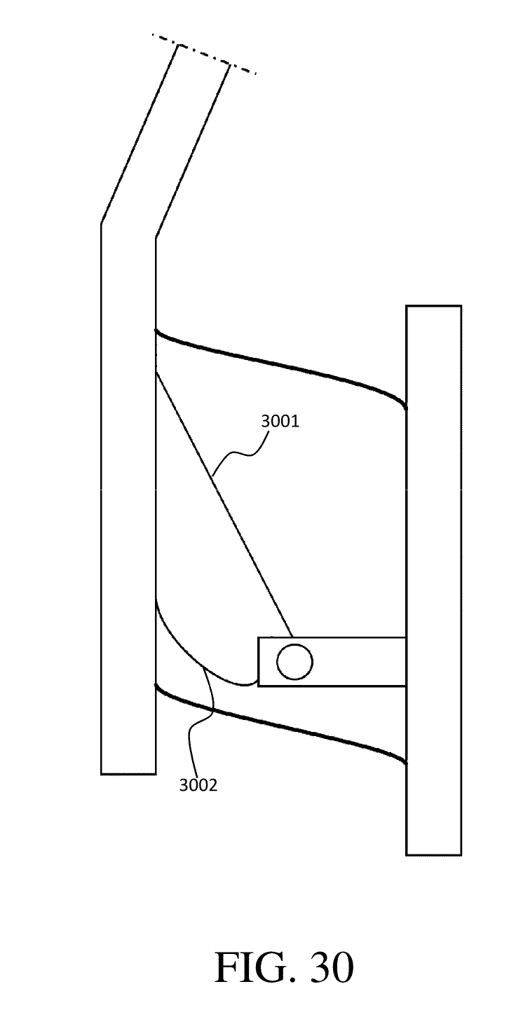

FIG. 30 shows an embodiment of the front wheel suspension system from FIG. 3 where the said two or more flexible members are pre-loaded by a tensioned string/strap 3001 between the wheel structure and the frame structure in rest position, furthermore a secondary string/strap 3002 provides bump-stop functionality for the mechanism and prevents the said two or more flexible members from mechanical failure under extreme loads. Said strap can be somewhat elastic.

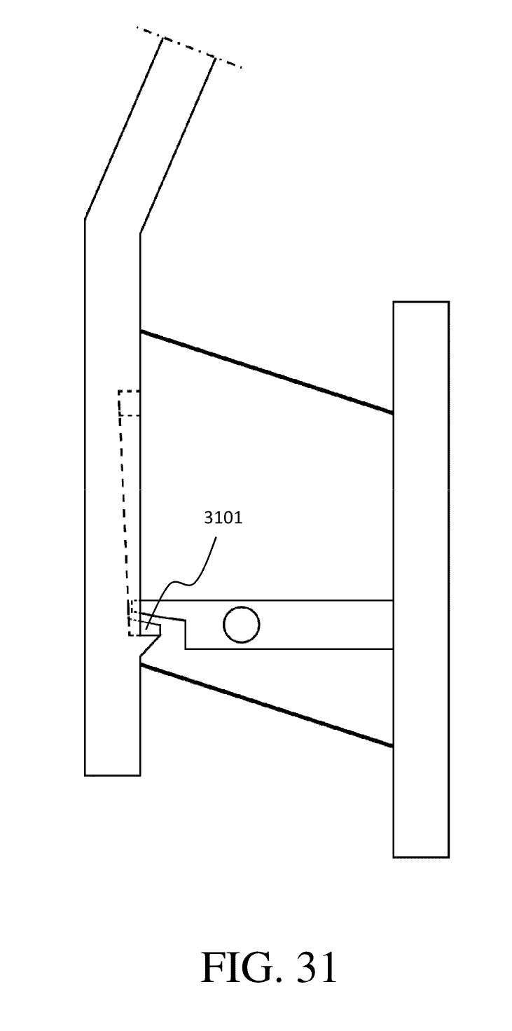

FIG. 31 shows a variation of the embodiment on FIG. 28 where during rest position the said resilient member 3101 is only in contact with either wheel structure or frame structure and can have some spacing towards the other part. Said spacing can be, but is not limited to being, up to 30 mm. In this configuration the resilient member does not pre-load the suspension system but gets in contact with the opposite part during excessive rebound and absorbs rebound energy.

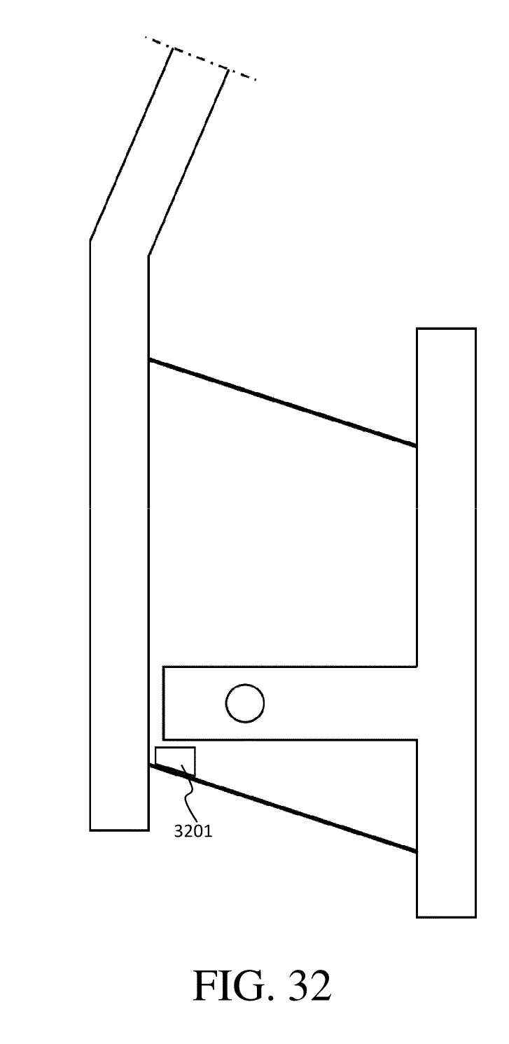

FIG. 32 shows a variation of the embodiment on FIG. 29 where during rest position the resilient member 3201 is only in contact with either wheel structure or, as shown here in contact with the upmost flexible member, so that when it is in rest position it has some spacing towards the other part. Said spacing can be, but is not limited to being up to 30 mm. In this configuration the resilient member does not pre-load the suspension system but gets in contact with the opposite part during excessive rebound and absorbs rebound energy.

Said resilient member may as an example be, but is not limited to being, a polyurethane pad, rubber pad, silicone pad or similar.

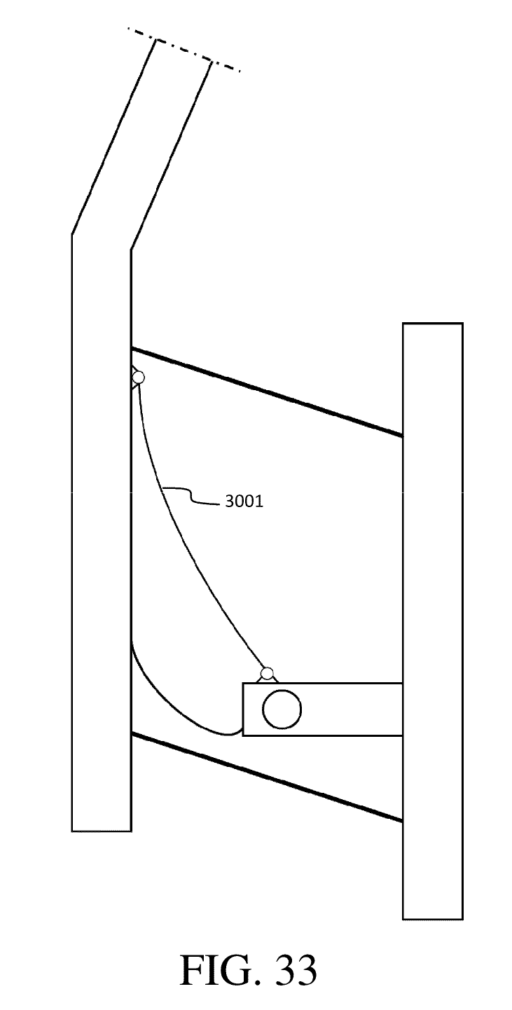

FIG. 33 shows a variation of the embodiment on FIG. 30 where during rest position the said strap 3001 that was pre-tensioned on FIG. 30 is not pre-tensioned but has some slack. In this configuration the said strap does not pre-load the suspension system but becomes tensioned during excessive rebound and absorbs rebound energy. Said strap may become tensioned when said wheel structure is pulled downwards relatively to said frame structure by up to 30 mm, when the rotational axis of the suspended wheel is parallel to the ground and front and rear wheels of said vehicle are horizontal to one another.

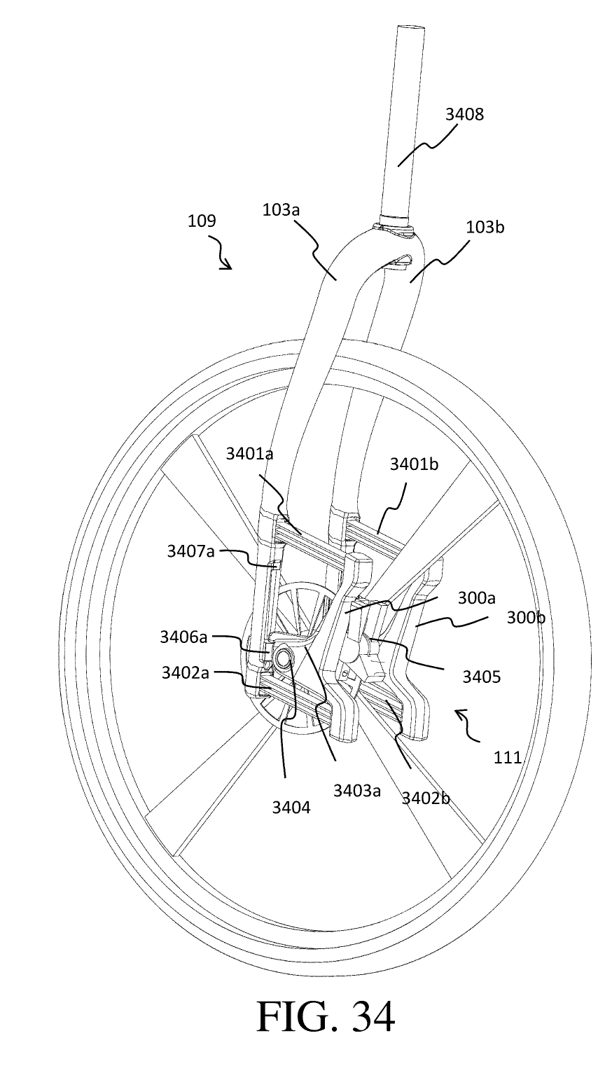

FIG. 34 shows a perspective view of a front wheel suspension system 100 according to the present invention (see e.g. FIG. 3), where each fork leg 103a, 103b comprises two vertically spaced flexible members or bundles of two or more tightly spaced flexible members 3401a,b 3402a,b, where the distance between the flexible members may be a fraction of a millimeter or up to several millimeters, and where they are rigidly mounted to corresponding fork legs and the ends of corresponding front wheel structure beams 300a,b of a front wheel structure 111 located posteriorly to said fork legs. The bundles of two or more tightly spaced flexible members are substantially parallel and of substantially equal length. The flexible members or bundles of two or more tightly spaced flexible members 3402a,b that are placed at the lower end of the wheel structure are below the front hub mount 3404 while the upper flexible members or bundles of two or more tightly spaced flexible members 3401a,b are located above the front hub mount. Said flexible members or bundles of two or more tightly spaced flexible members may be tilted upwards, looking from the wheel structure 111 and towards the fork legs of the frame structure 109, by an angle which may as an example be, but is not limited to, between 5° to 25° relatively to a plane perpendicular to a line running through the fork's steerer tube 3408, making the suspension more responsive to frontal impacts during the first part of its motion through the travel and capable of having a higher maximal suspension travel. Said front wheel structure may comprise anteriorly protruding parts 3403a, 3403b (3403b not shown) comprising a hub mount 3404, a rigidly mounted disc-brake caliper 3405 on either side, resilient members 3406a, 3406b (3406b not shown) providing pre-load of the suspension system and/or absorbing excessive rebound energy and resilient members 3407a, 3407b (3407b not shown) providing bump-stop functionality of the suspension system and preventing flexible members from mechanical failure under extreme loads.

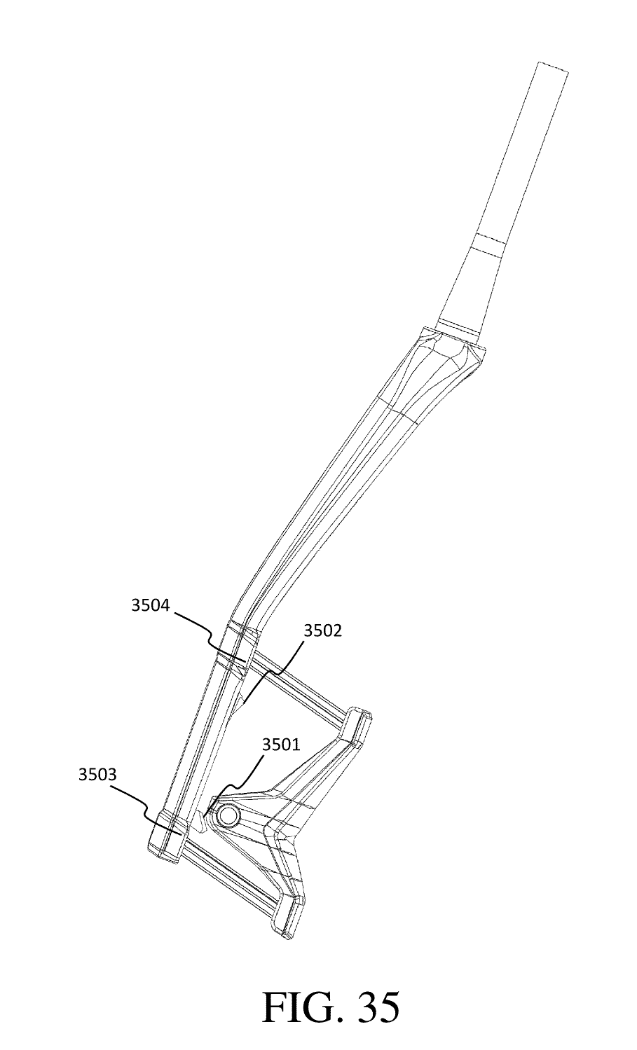

FIG. 35 depicts one variation of the embodiment from FIG. 34 the said front wheel suspension system has its resilient member(s) 3501 and/or resilient member(s) 3502 providing pre-load of the suspension system and/or absorbing excessive rebound energy located by or just above the lower flexible member pocket or stack of flexible member pockets 3503 on the two legged fork of said front wheel suspension system. Where “by or just above” refers to a distance between 0 and 50 mm, such as 0-20 mm. Said resilient member may be at a position so that it is squeezed between the frame structure and wheel structure in rest position or when e.g. said wheel structure is pulled downwards by up to 30 mm relatively to said frame structure, when the rotational axis of the suspended wheel is parallel to the ground and front and rear wheels of said vehicle are horizontal to one another. Thus, excessive rebound of the suspension system may be prevented. The resilient member(s) 3502 that provides bump-stop functionality may be located below the upper flexible member pocket or stack of flexible member pockets 3504 on the two legged fork of said front wheel suspension system so that they are squeezed between the frame structure and wheel structure when e.g. said wheel structure is pulled upwards by between 10 to 120 mm, such as 20-80 mm, when the rotational axis of the suspended wheel is parallel to the ground and front and rear wheels of said vehicle are horizontal to one another. In this configuration the said resilient members, both the ones providing pre-load and/or absorbing excessive rebound energy and the ones providing bump-stop functionality, are not to the same extent submerged into a recess on said two legged fork as in FIG. 34.

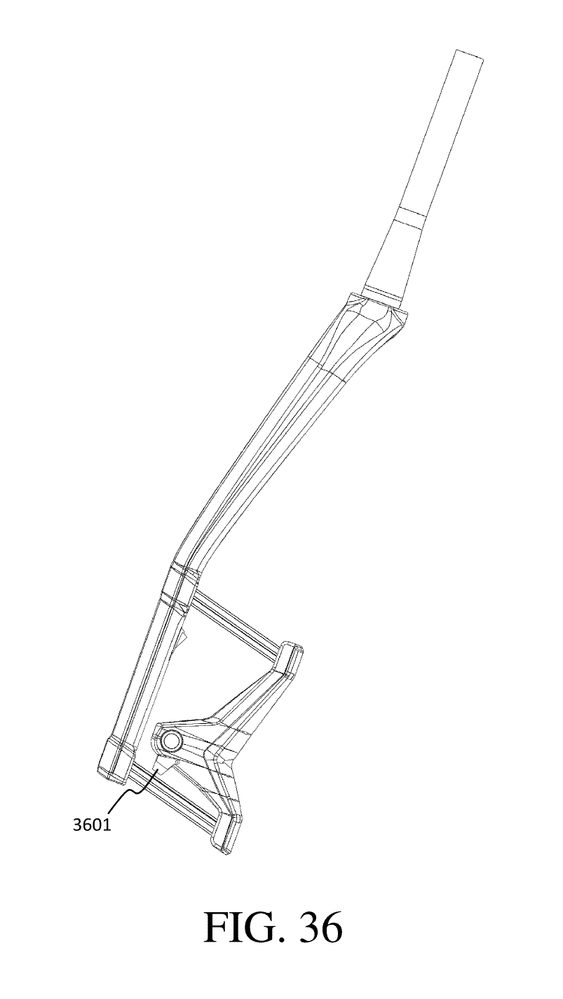

FIG. 36 shows a variation of FIGS. 34-35 where said resilient member(s) 3601 absorbing excessive rebound of the suspension system may be attached underneath the wheel structure, either to the said wheel structure or on top of the upmost flexible member below said wheel structure. Said resilient member is at a position so that it is squeezed between the wheel structure and the said one or more out of said at least two flexible members in rest position or when e.g. said wheel structure is pulled downwards by up to 30 mm relatively to said frame structure, when the rotational axis of the suspended wheel is parallel to the ground and front and rear wheels of said vehicle are horizontal to one another. Thus, excessive rebound of the suspension system may be prevented.

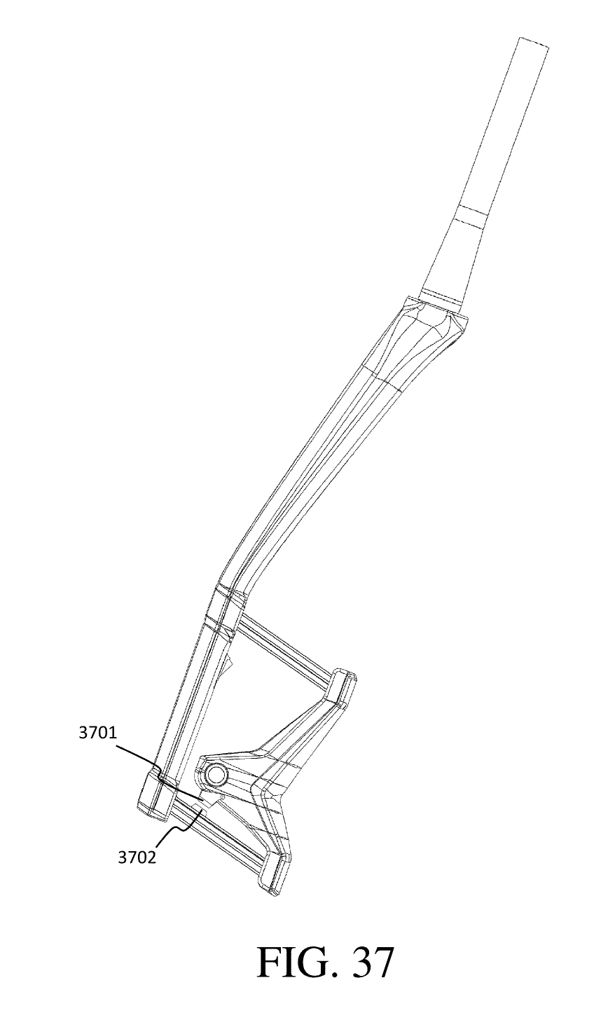

FIG. 37 shows one variation of the embodiments from FIGS. 28-29, FIGS. 31-32 and FIGS. 34-36 where the said resilient member 3701 may be attached to wheel structure, frame structure or a flexible member does not get in direct contact with the respective opposite side as described in the said figures. In this variation the respective opposite side comprises a resilient means 3702 of receiving and distributing the load said resilient member puts on said opposite structure. This figure shows the case where said resilient member and said resilient means of receiving and distributing load are attached to wheel structure and flexible member, respectively. This positioning of said resilient member and resilient means is just an example of possible locations, they could be positioned according to any of FIGS. 28-29, FIGS. 31-32 or FIGS. 34-36 in a similar manner.

In one embodiment one or more of said resilient members are attached to said suspension system via gluing.

In one embodiment one or more of said resilient members are attached to said suspension system via threaded inserts in either frame structure or wheel structure.

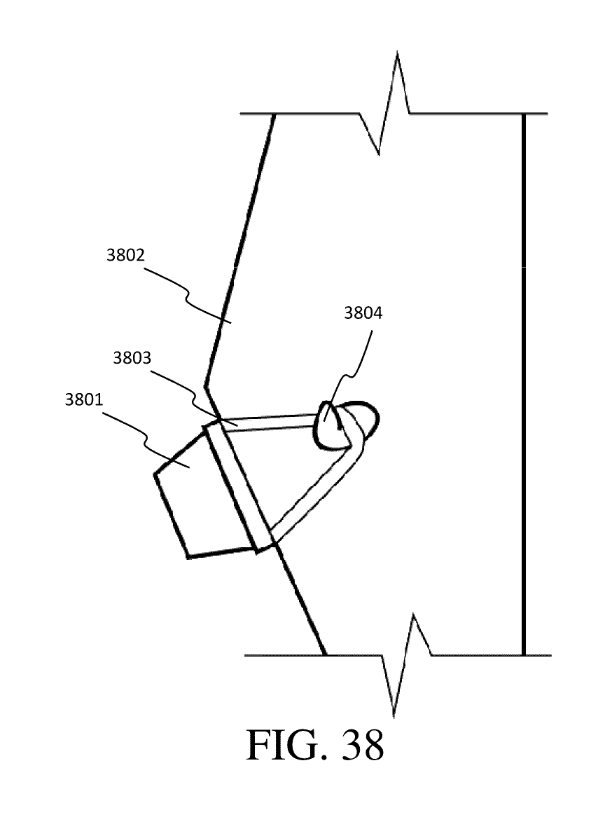

FIG. 38 shows an embodiment of attaching one or more of said resilient members 3801 of said suspension system to a structure 3802, said structure being either said wheel structure or frame structure, via attachment means 3804 on corresponding structure and another attachment means 3803 on said resilient member. These attachment means are e.g. hooked together, providing a quick and simple method of replacing said resilient member.

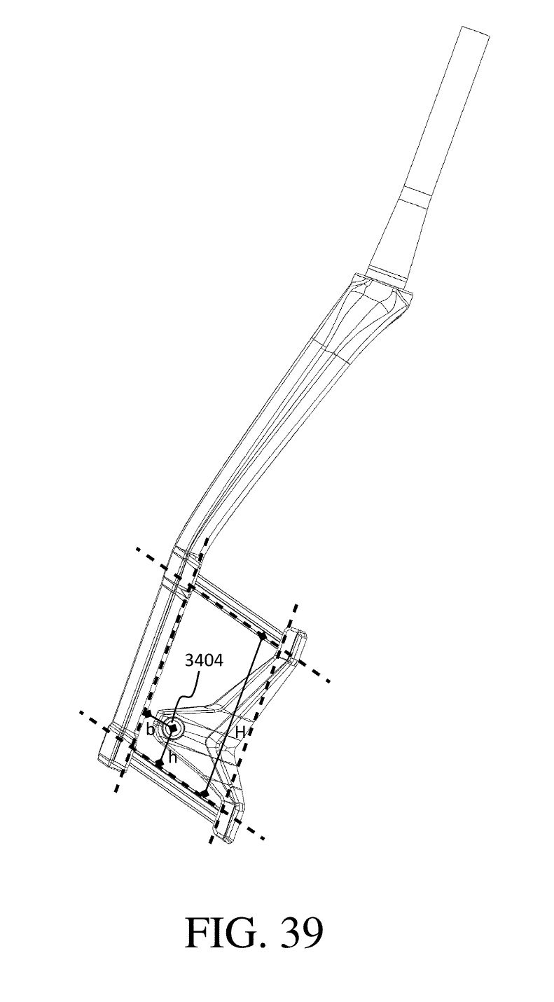

FIG. 39 shows an embodiment of a front wheel suspension system according to the present invention, showing where the hub mounts 3204 may be positioned such that at least one flexible member is positioned above the hub mounts 3204 and at least one flexible member is positioned below the hub mounts 3204. As depicted here as an example, three flexible members are positioned above and below the hub mounts, respectively, but the number of flexible members could just as well be more than three or less than three.

Said hub mount 3204 is preferably located within an envelope defined by the dotted lines. This figure defines the dimensions h, H and b that are subsequently referred to in the following text.

In one variation of the embodiment described in FIG. 39 h≦H/2. Thus, the pictured location according to the said dimensions enables the said two legged fork of the suspension system to not having to reach too far towards the ground (with increase in bulkiness and weight), yet the system is close enough to the ground so that it does effectively resist lateral forces e.g. when a bicycle using said suspension system is ridden aggressively through a turn.

In one variation of the embodiment described in FIG. 39 □≦60□□ such as □≦35□□. Thus, the pictured location according to the said dimensions enables the said two legged fork of the suspension system to not having to reach too far forwards while maintaining a certain rake (rake is a standardized bicycle industry method of measuring the offset of a front wheel hub from the rotational axis of its steerer tube) of the front wheel. This allows for a system where the said wheel side structure and said two legged front fork structure of the frame structure are close enough to one another so that it's simple to install resilient members between the parts that provide bump-stop functionality and/or provide preload and/or absorption of excessive rebound energy, such as according to any of FIGS. 28-29, FIGS. 31-32 and FIGS. 34-38. Furthermore, having said two legged fork of the suspension system not having to reach too far forwards makes for a lightweight and aesthetically pleasing front suspension system.

In one embodiment said wheel structures and or frame structure are made of metal or a composite material such as but not limited to; aluminum, magnesium, titanium, steel, resin impregnated carbon fiber, glass fiber, flax fiber, aramid fiber, boron fiber or basalt fiber.

In the present invention there may be a need for flexible members and means of attaching those flexible members to surrounding structure that provide good lateral rigidity of the suspension system while also allowing; substantial travel of the suspension system, low weight, efficient manufacturing methods, good structural strength and safety.

A lack of lateral rigidity results in a suspension system where the suspended wheel is poorly guided along its appropriate plane of movement and the rider may experience less accuracy and controllability of the bike.

To achieve lateral rigidity of the said suspension system there are key elements, elements that are not present in conventional bicycle suspension, of the said suspension system that need to be designed extra carefully. These are the two or more flexible members of the said suspension system and the connections of the said two or more flexible members to the frame and/or wheel structures.

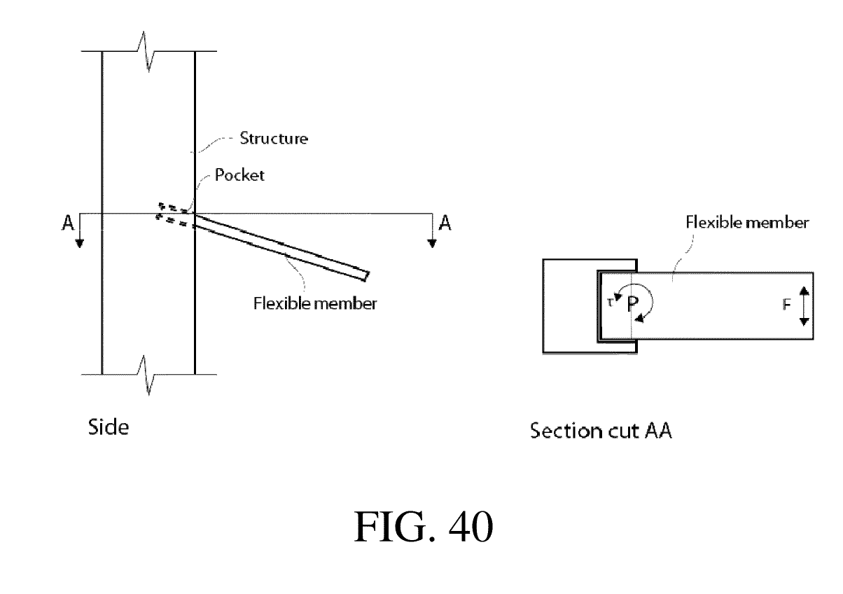

The connections of the said two or more flexible members to its surrounding structure have to be rigid against input moment so that the said flexible members cannot easily be turned towards either lateral side. FIG. 40 depicts the moment, r, a single connection has to be rigid against. To achieve this, the said two or more flexible members have to be rigidly connected to their pockets and the pockets rigidly connected to surrounding structure.

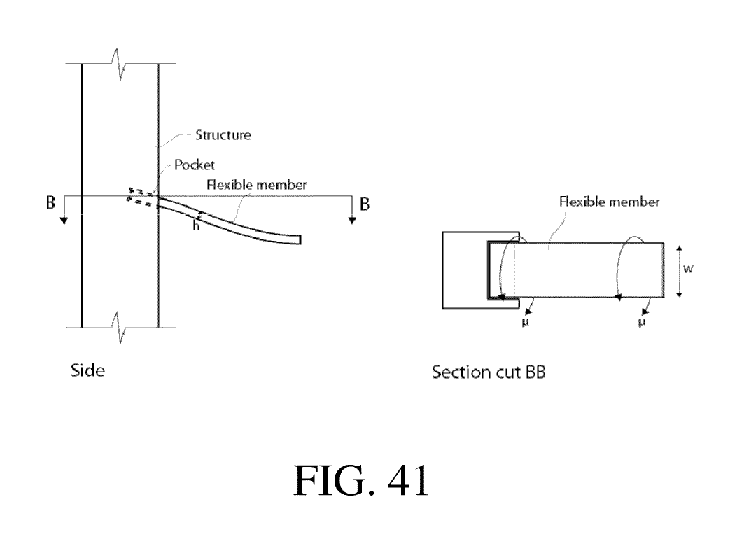

For the said two or more flexible members to be laterally rigid there are two different scenarios. In the case when the suspension system is in rest position this rigidity is dependent on the moment of inertia, I, of the said flexible members; I=ŵ3*h/12 (as depicted on FIG. 41, where w stands for the width of a said flexible member and h stands for its thickness). Hence, to achieve lateral rigidity a said flexible member should be substantially wider than it is thick. Making said flexible member wider has no negative effect on the flexural performance of the said flexible member in the intended direction of the suspension travel. Therefore, in this case lateral rigidity is relatively easy to obtain, the said flexible member is simply made wide enough. If for example a flexible member is made 10 times wider than it is thick then it will be 10̂2=100 times stiffer laterally than in the intended movement direction of the suspension (assuming the flexible member is made out of a homogeneous material). However, when the suspension system is into its travel, as depicted on FIG. 41, the lateral loading scenario of the flexible members becomes different. Now the lateral forces also try to twist the flexible members with moment μ. As a result, in order to create a laterally rigid suspension system, the flexible members have to be designed so that they are torsionally rigid, without compromising too much on the flexural performance of the flexible members in the intended direction of the suspension.

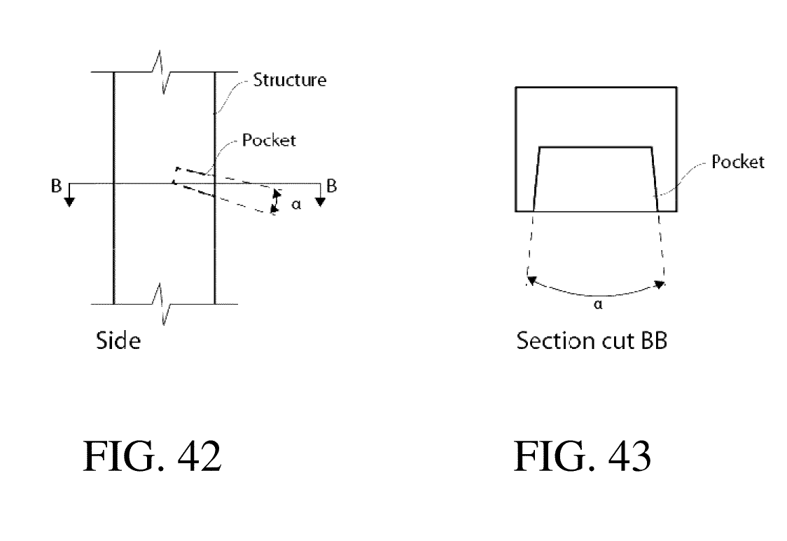

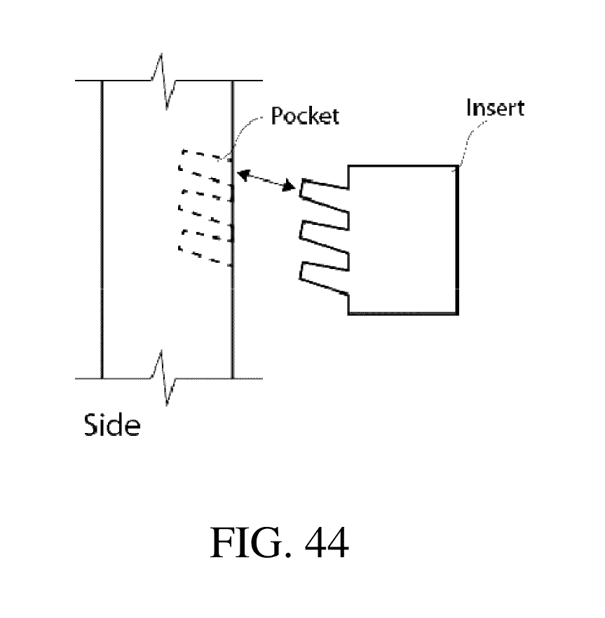

FIGS. 42-44—show a variation of the embodiments from FIGS. 14-23 where one or more pockets, each attaching one flexible member end of one of the said two or more flexible members may have a draft angle α of between 0 and 3 degrees, so that the pockets are never substantially wider at the bottom than at the opening. This enables an internally molded (i.e. where a mold fills a pocket during the molding process) pocket to be released from its mold as shown in FIG. 44, yet the draft is low enough so that a gluing of a said flexible member into the pocket will function properly.

In one variation of the one or more pockets from FIGS. 42-44 the said one or more pockets each extend along a substantially straight line into corresponding structure, said structure being a front wheel structure, rear wheel structure or a frame structure.

Thus, said pockets are particularly suitable for attaching one or more out of said at least two flexible members with straight ends.

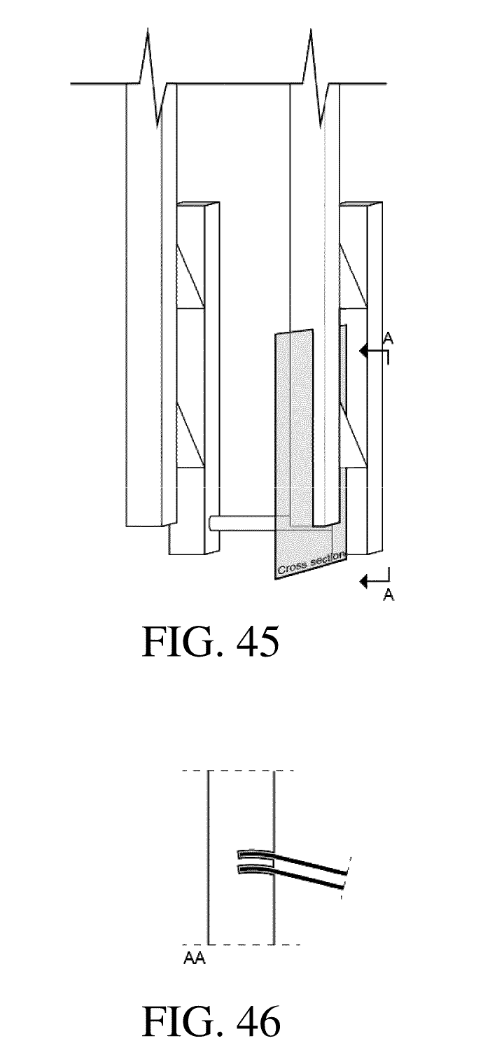

FIG. 45-46 describe one variation of the one or more pockets from FIGS. 42-44 where the said one or more pockets each extend into corresponding structure along a line with a substantially fixed radius and in the case of tightly spaced pockets, with height less than 25 mm between pockets when said vehicle suspension system is in a vertical position in relation to the ground i.e. the rotational axis of the suspended wheel being parallel to the ground and front and rear wheels of said vehicle are horizontal to one another, these radiuses are around a substantially common origin and are larger than 30 mm.

Thus, said pockets are particularly suitable for attaching one or more out of said at least two flexible members with ends curved with a similar radius as the corresponding said one or more pockets and geometric conditions of the pockets will not prevent internally molded (i.e. where a mold fills pockets during the molding process) pockets to be released from a mold.

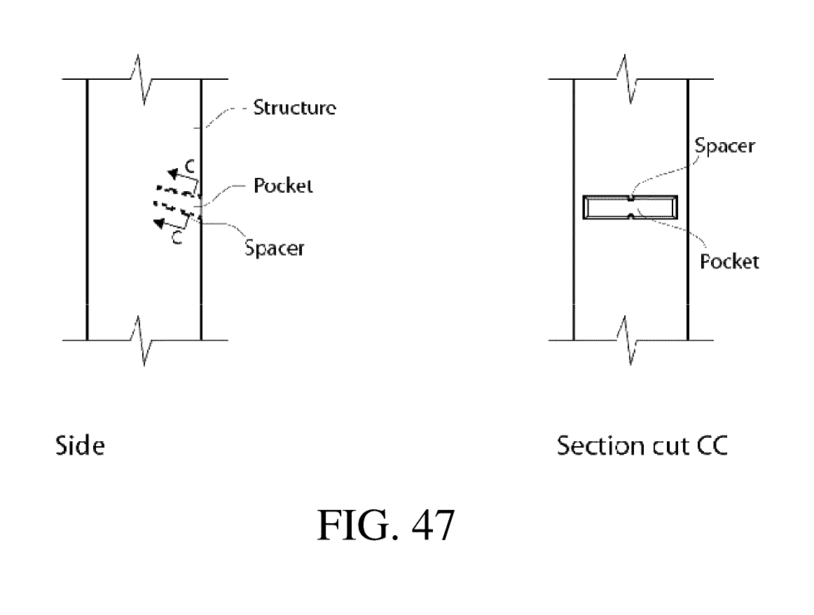

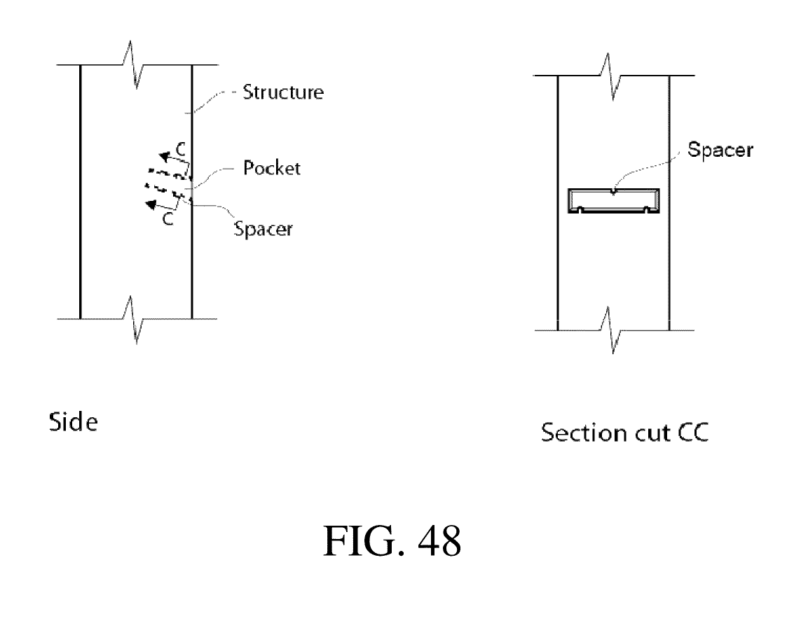

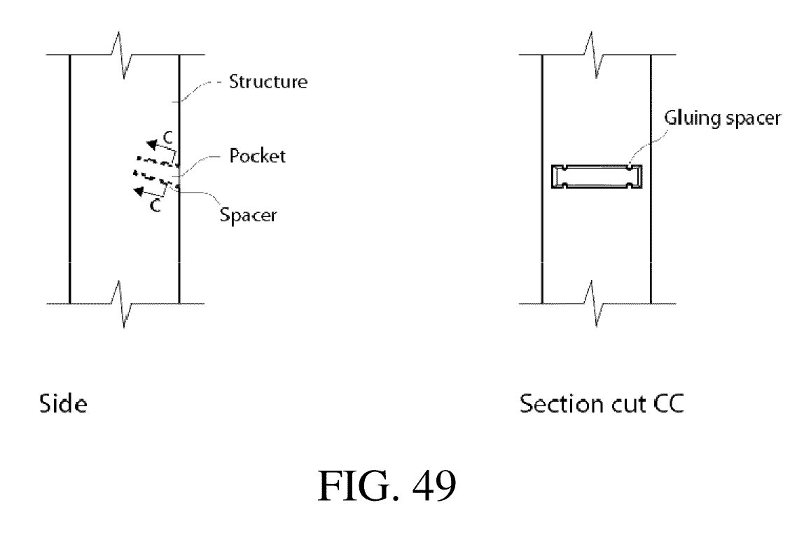

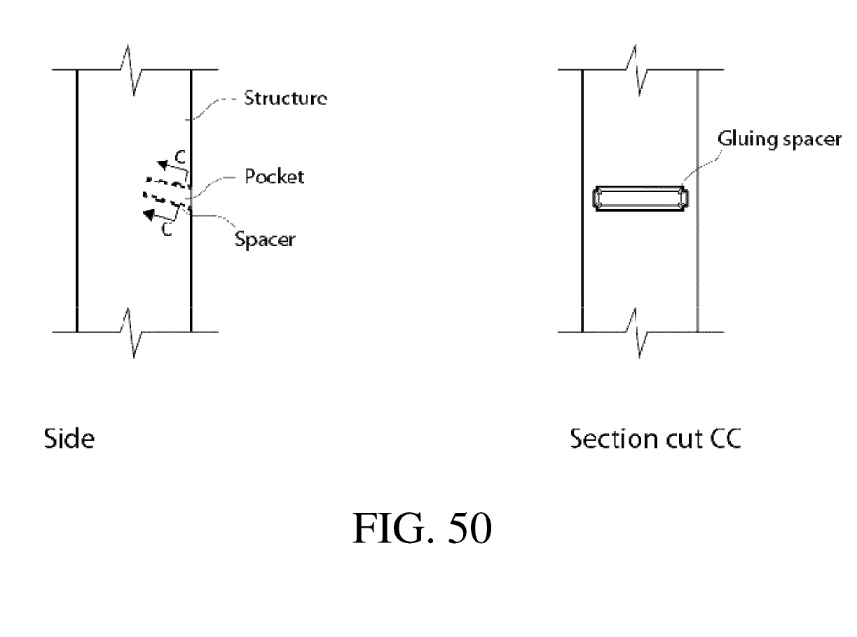

FIGS. 47-50—Show a variation of the embodiment of the one or more pockets in FIGS. 42-46 with one or more extrusions on each side of the said inserted flexible member as a built-in part of the said pocket. These extrusions provide a tighter fit to the inserted flexible member than the rest of the pocket does. Hence, they make sure that when the flexible member is inserted into the pocket, where glue has been applied to either or both the flexible member and the pocket, the glue will be less prone to get scraped off the flexible member or pocket, respectively, during insertion of the flexible member into the pocket. Furthermore, if the flexible member is inserted into the pocket without any glue applied to the pocket and the flexible member these extrusions create glue flow paths that make it possible to inject glue into the dry assembly without the risk of substantially uneven glue distribution.

In one variation of the embodiments from FIGS. 47-50 one or more out of said extrusions do not reach all the way to the opening of the said one or more pockets. In one variation the said one or more extrusions are between 1 and 10 millimeters, such as 1-5 millimeters, from reaching the opening of the said one or more pockets. This creates an even edge on the opening of said one or more pockets, preventing the flexible members from being stressed unevenly when flexed during suspension travel.

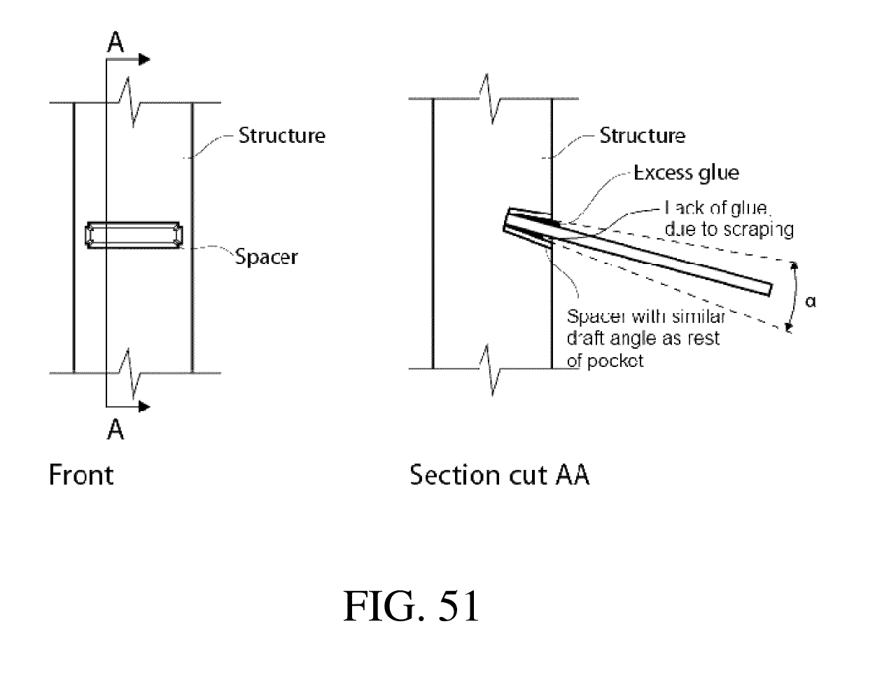

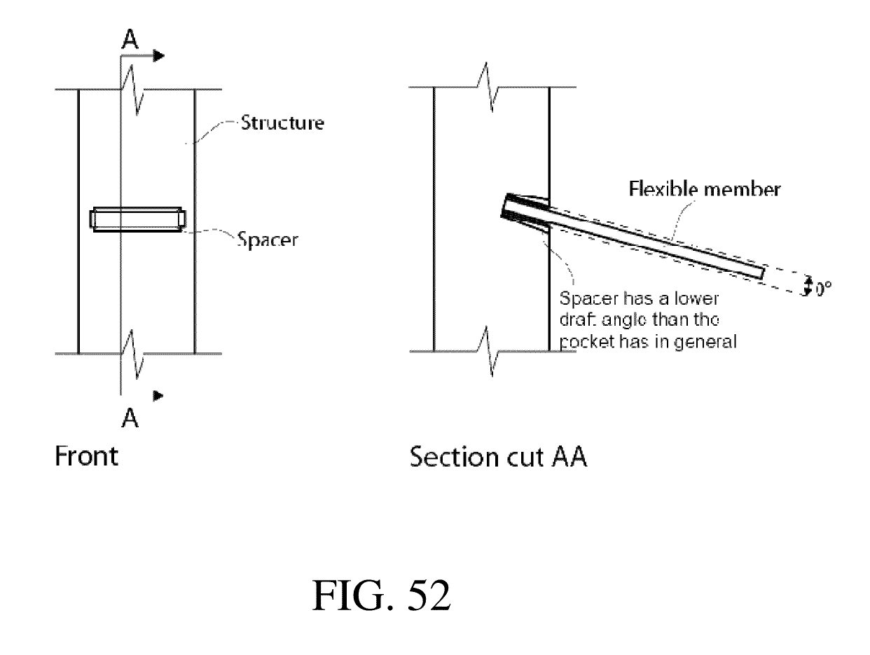

FIGS. 51-52 shows a variation of the embodiments in FIGS. 42-50 where the parts of the said pocket that make up the said extrusions have a lower draft angle than the pocket otherwise has. This makes sure that when inserting a said flexible member into a pocket with a substantial draft angle the flexible member is further constrained from moving up or down during the gluing process. This prevents the flexible member from pushing glue out of the pocket and consequently damaging the quality of the gluing.

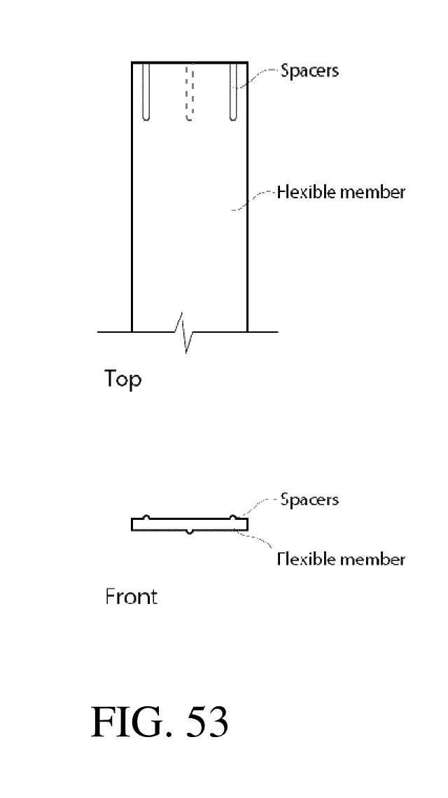

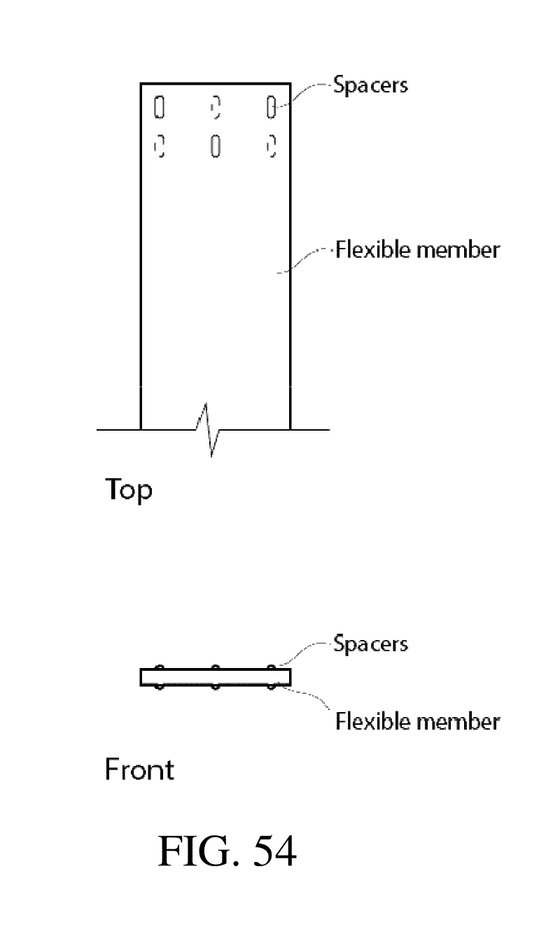

FIGS. 53-54—show variations of the embodiments in FIGS. 42-52 where the said gluing extrusions are a built-in part of the said flexible member rather than being a part of the said pocket.

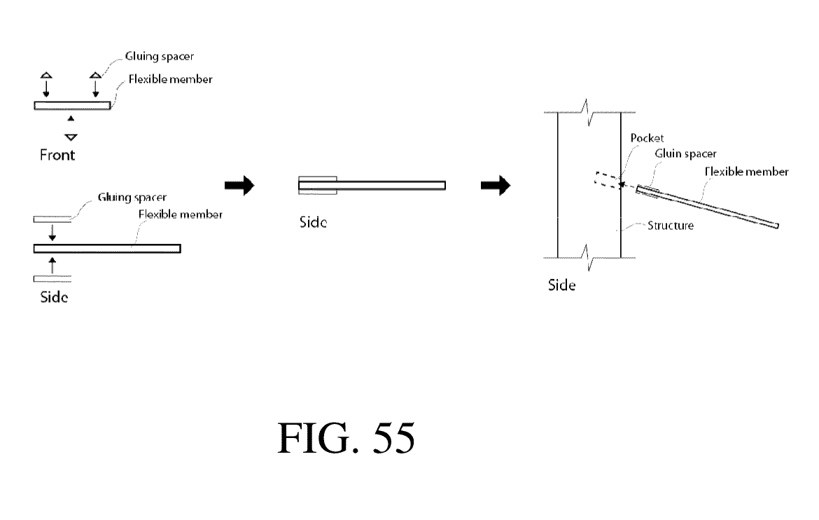

FIG. 55 shows one variation of the embodiments from FIGS. 42 to 54 the said gluing extrusions are retrofitted to either the said pocket or flexible member before inserting the flexible members into the pocket. The retrofitting can be done by e.g. gluing.

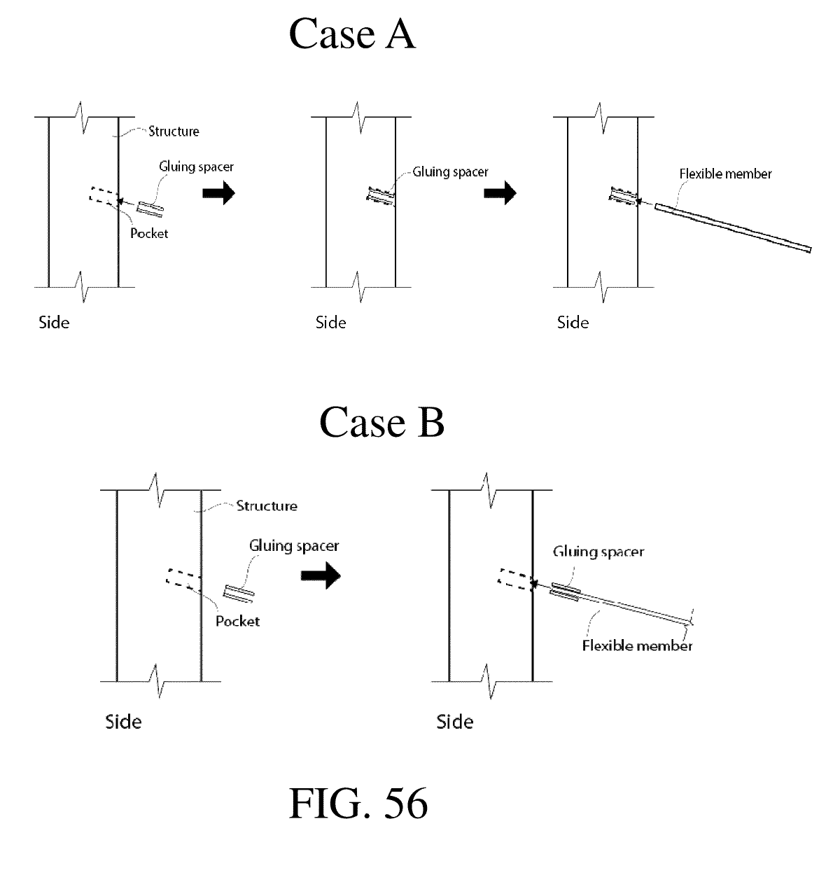

FIG. 56 shows variations of the embodiments in FIGS. 42-55 where the said gluing extrusions are inserted between the said pocket and flexible member, either by wrapping the inserts around the end of the flexible member before inserting the flexible member into the pocket (as shown in case B in the figure) or inserting the gluing spacers into the pocket before inserting the flexible member into the pocket (as shown in case A).

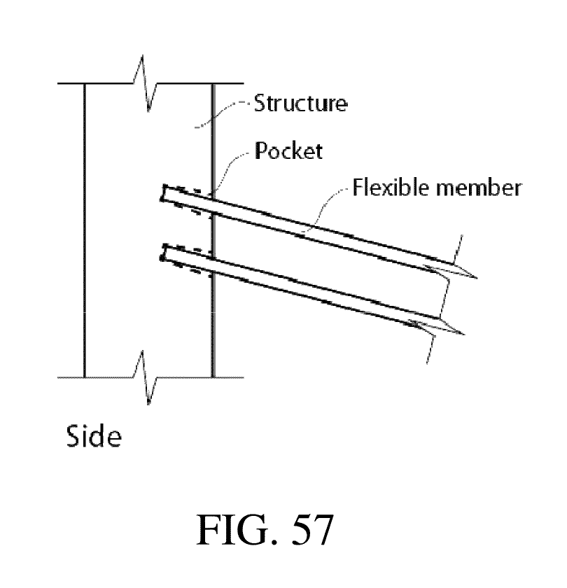

FIG. 57 shows a variation of the embodiments from FIGS. 42-56 where two or more of the said pockets form a tight stack of two or more pockets.

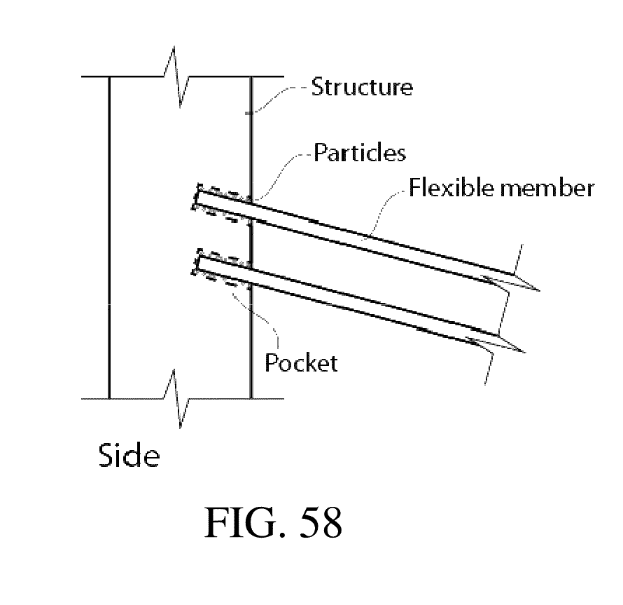

FIG. 58 shows a variation of the embodiment from FIGS. 42-57 where the glue gap between the said pocket and said inserted flexible members is controlled by particles in the glue.

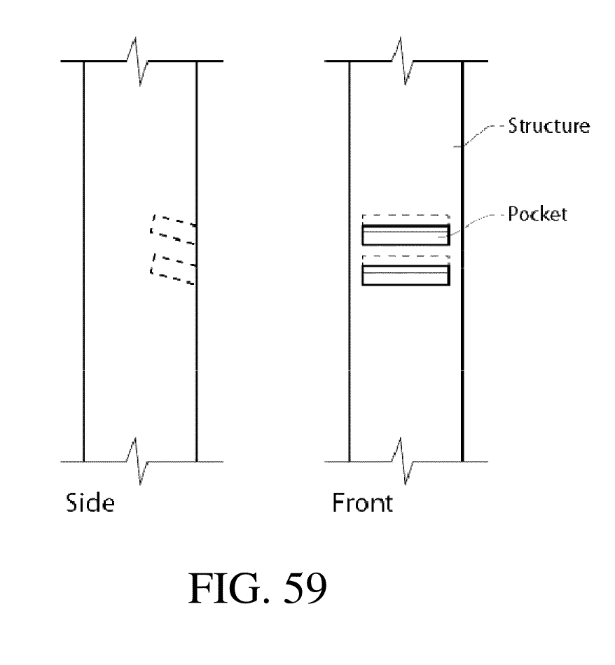

FIG. 59 shows an embodiment of the said suspension system where said one or more pockets are a seamless integrated part of their surrounding hollow said wheel or frame structure, i.e. the pockets are not retrofitted to surrounding structure by fastening methods such as gluing, bolting or similar. An example of this is when said one or more pockets made of fiber reinforced resin in a fiber reinforced resin structure are cured as a part of its surrounding structure in the same process as its surrounding structure. Another example is when said one or more pockets are machined into the structure by methods such as milling, or in the case of a metal structure said one or more pockets are welded onto their surrounding metal structure and/or machined into the surrounding metal structure by methods such as milling or EDM (Electrical Discharge Machining) or made in the same process by e.g. casting or forging.

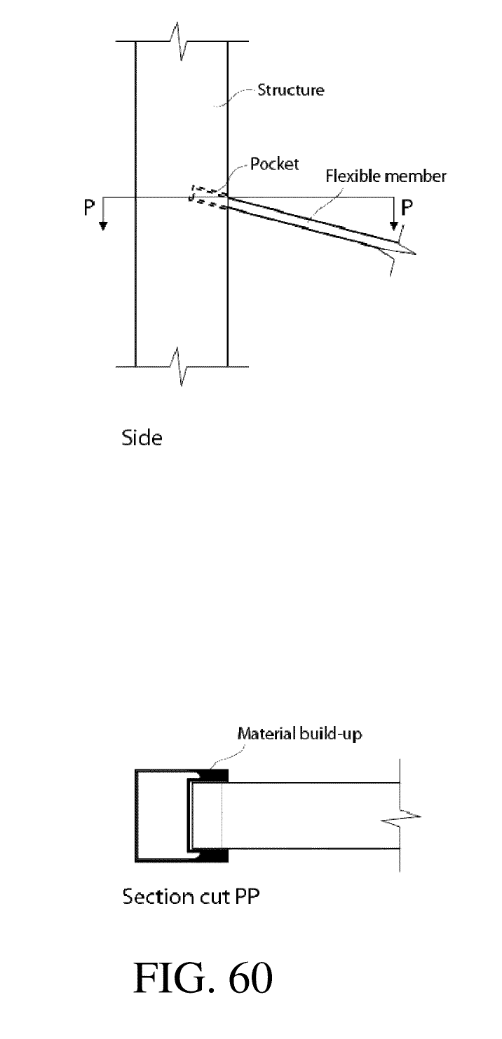

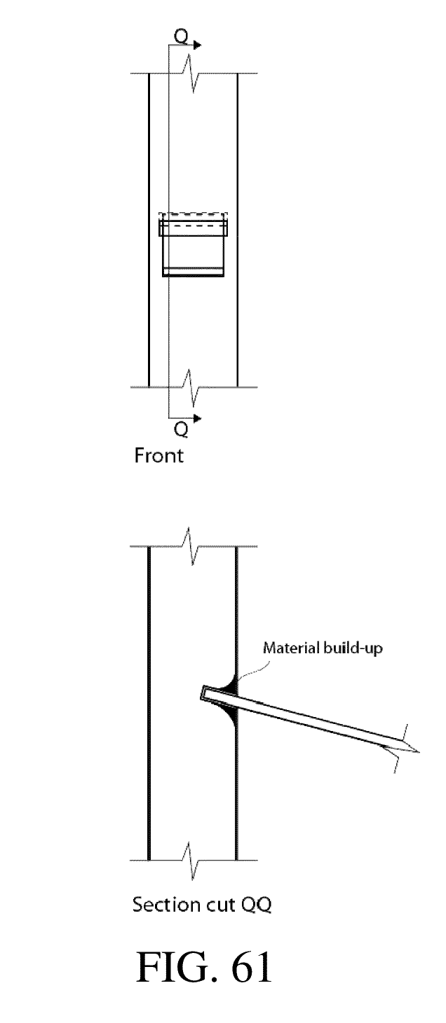

FIGS. 60-61 show an embodiment of the said wheel or frame structure and said one or more pockets where the pocket has a significantly increased material thickness of its hollow structure in the area connecting said one or more pocket to surrounding structure. This is done to prevent flex of the structure around said one or more pockets that would otherwise make the one or more attached flexible members lack rigidity against lateral input forces to the said suspension system. The figures show section cuts, P and Q, through one out of the one or more said pockets and surrounding structure, with a flexible member attached into the pocket.

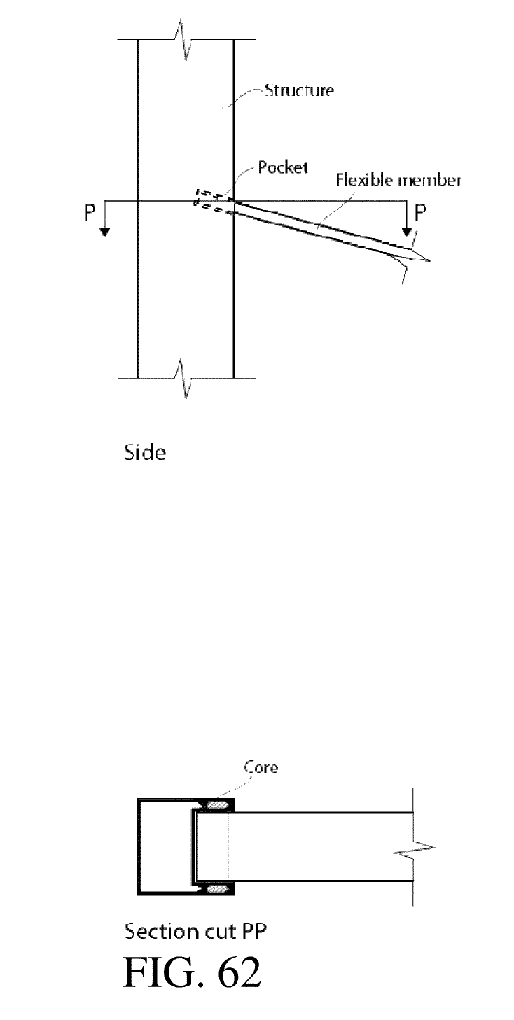

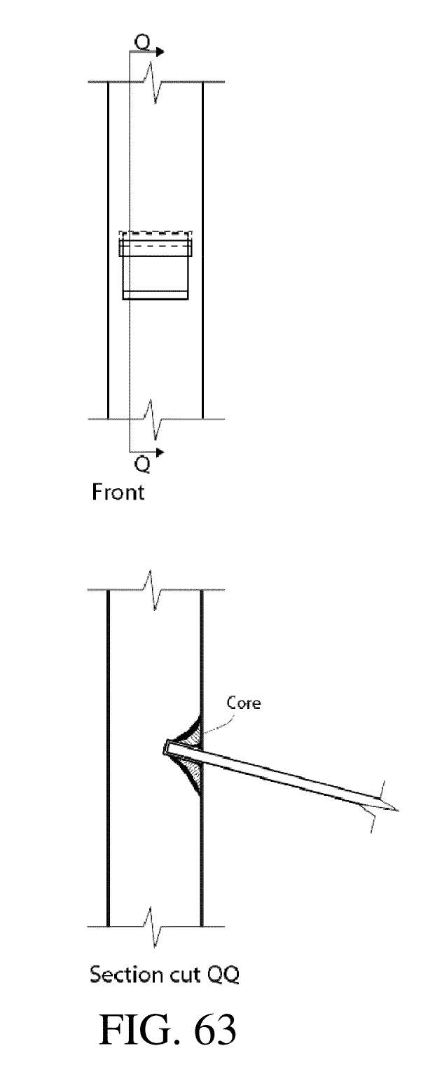

FIGS. 62-63 show one variation of the embodiment shown in FIGS. 60-61 the increased material thickness of the said hollow structure above and or below a pocket is further enhanced by the use of a lightweight core material.

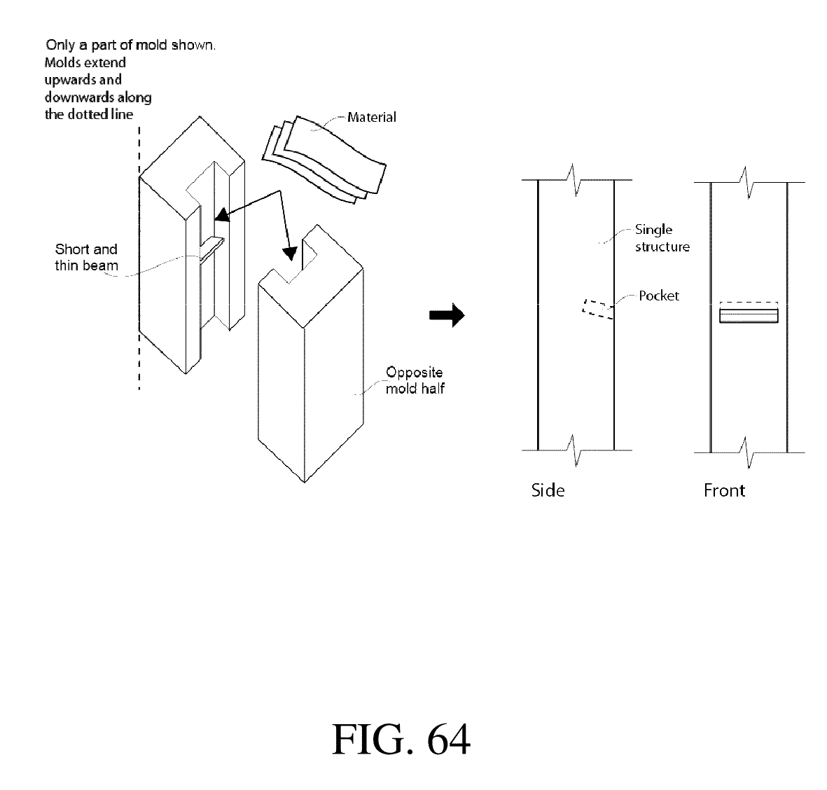

FIG. 64 describes a method of creating said one or more pockets and surrounding said wheel or frame structure in a single molding process. The pockets into the structure are created by one or more short and thin beams sticking into the mold.

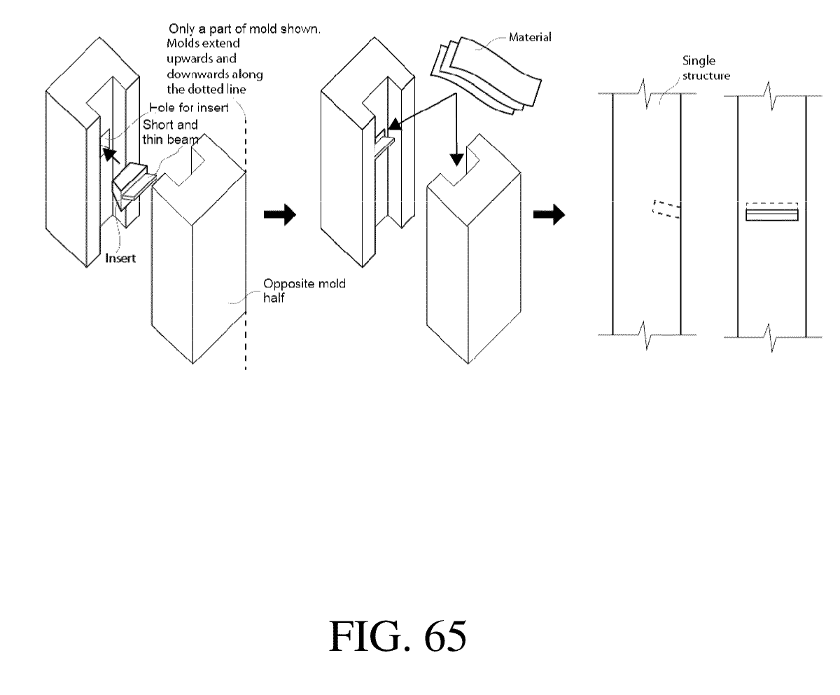

FIG. 65 shows one variation of the embodiment from FIG. 64 the said one or more short and thin beams sticking into the mold belong to one or more inserts in the mold, and not the main mold itself. The inserts facilitate easy replacement of the said beams for either easily achieving a different pocket design or simply replacing the said beams when they are worn out, as the beams can be a high wear part of the mold and thus last shorter than the rest of the mold. Furthermore, the inserts enable different pull angles of the molded part than would otherwise be possible. When inserts are not used the said short and thin beams with their low draft angles dictate the pull angle of the whole molded part, this can cause problems as other parts of the part might require a different pull angle.

The following figures that show different fiber paths around said one or more short and thin beams only show one direction of each fiber starting from the centerline seen on the figures. The other direction of the fiber (the one that is not shown) does not have to follow a path obtained by mirroring the shown fiber path, it can choose a mirrored path of any of the other described paths that intersect the centerline in the same manner. Showing this other end of the fiber is considered trivial as all the same principles apply on that side as well.

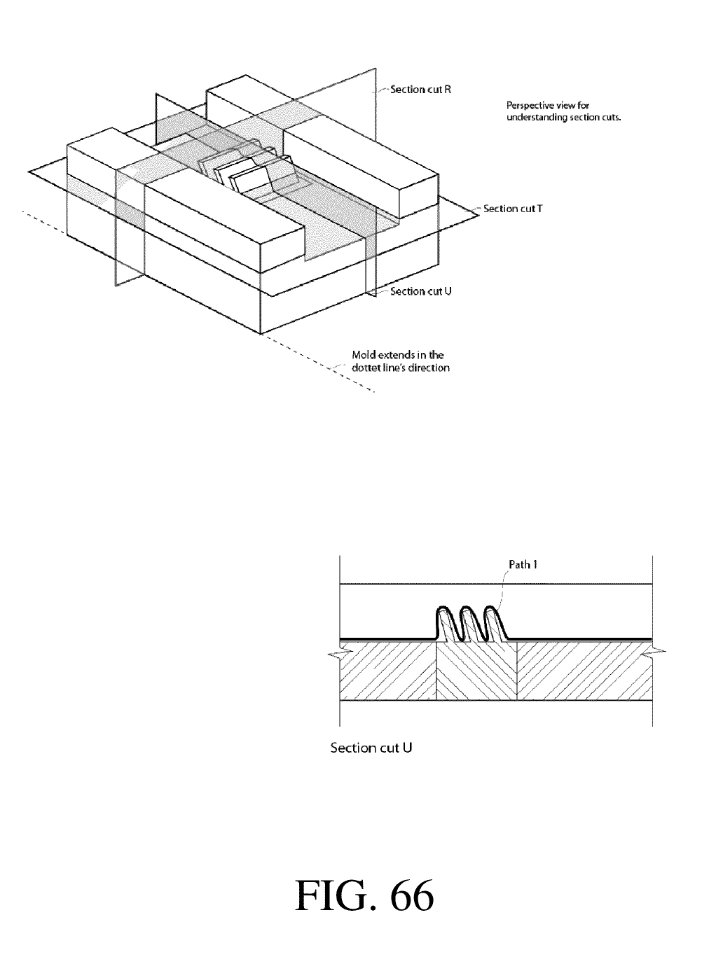

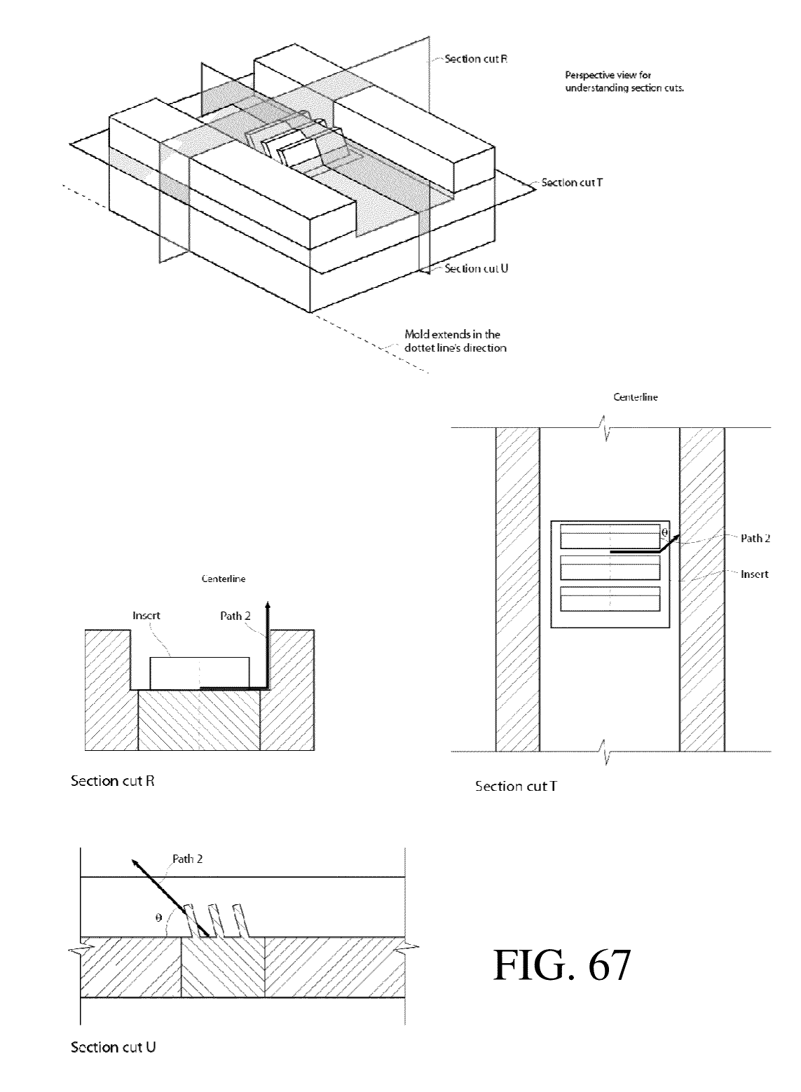

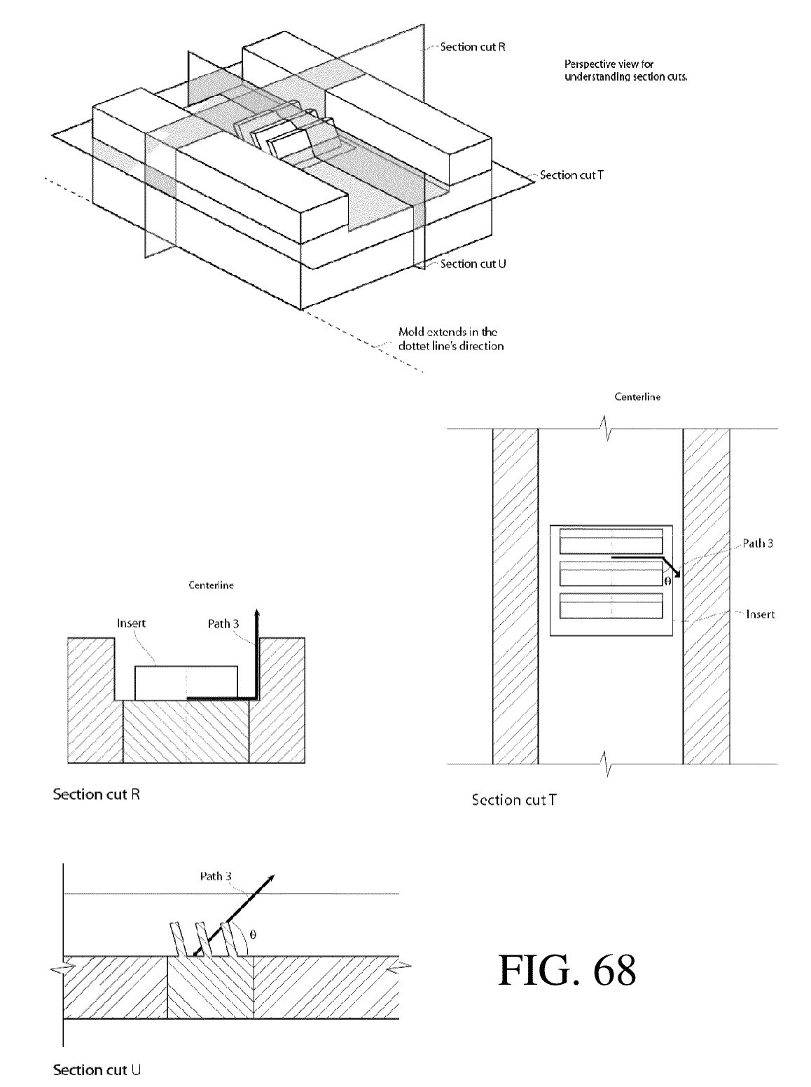

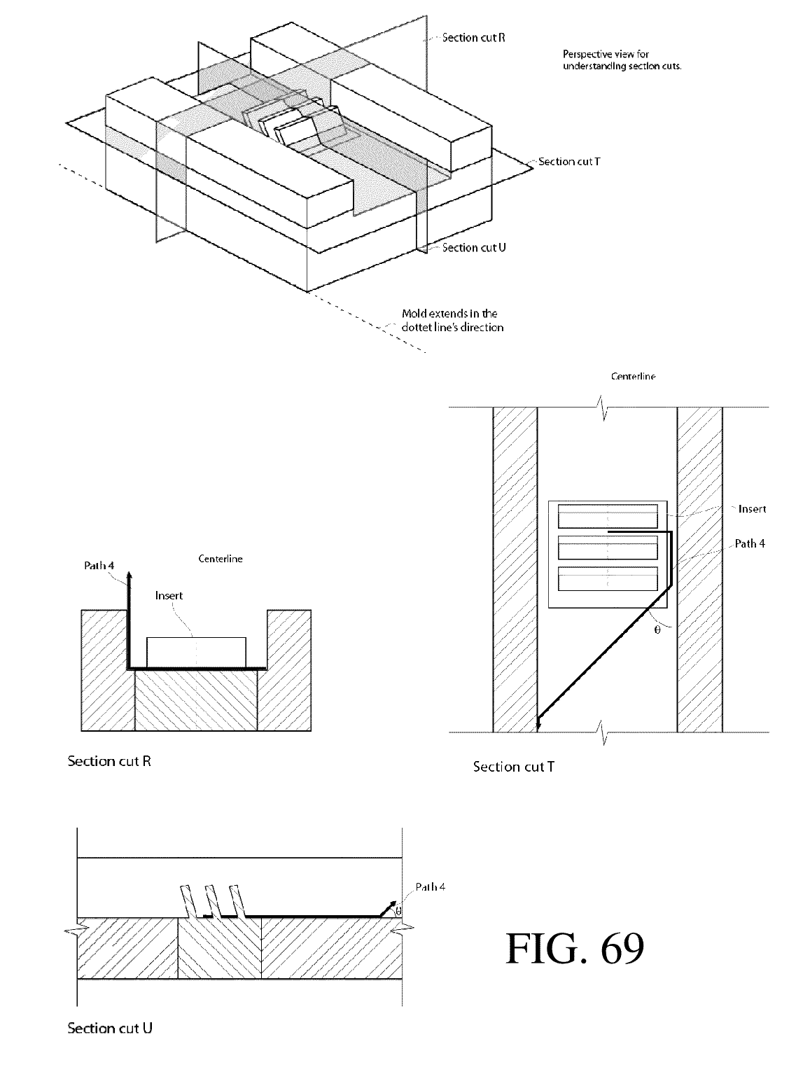

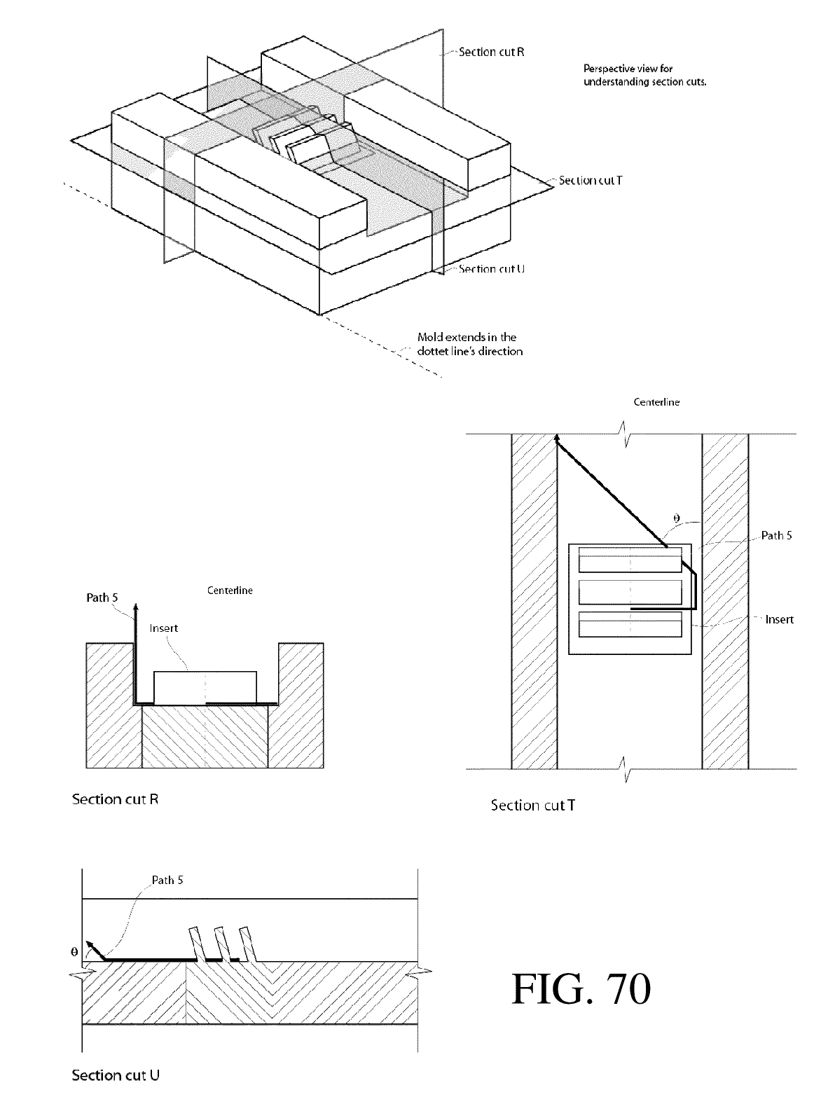

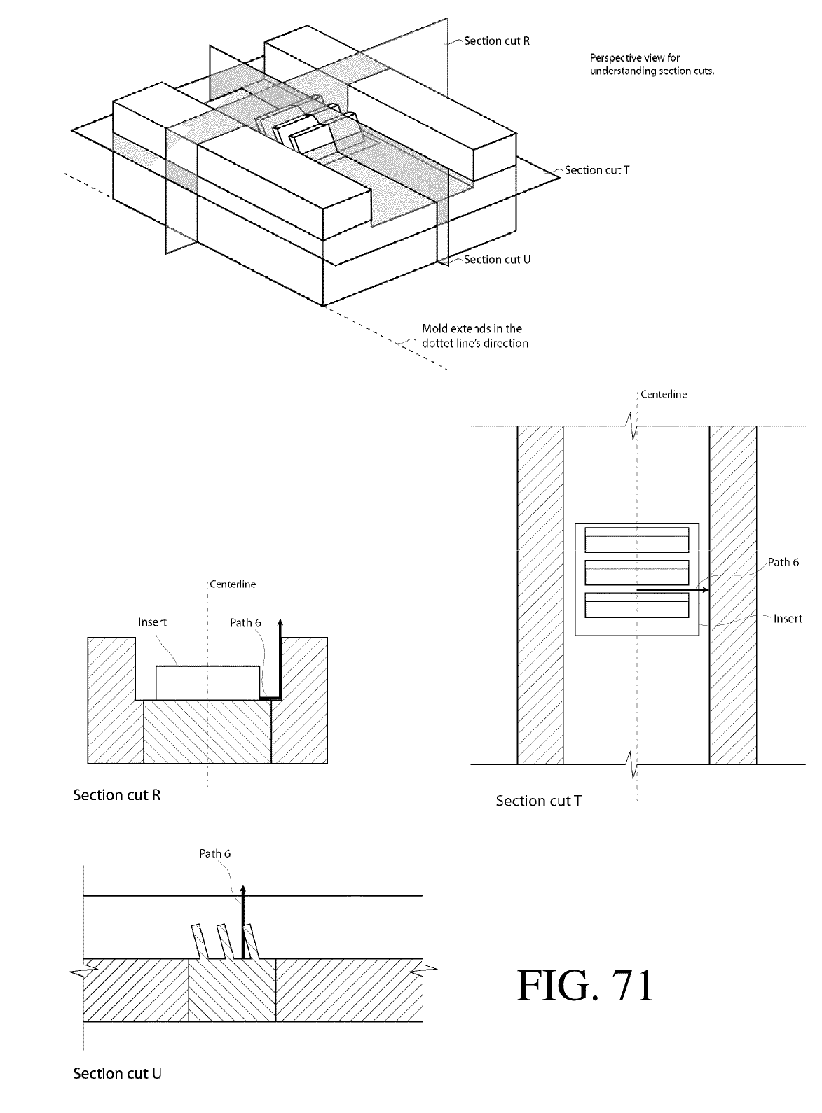

FIGS. 66-71 show one variation of the embodiments from FIGS. 64-65 the molded part is made out of a fiber reinforced resin material such as, but not limited to; carbon fiber reinforced resin, basalt fiber reinforced resin, kevlar fiber reinforced resin, boron fiber reinforced resin or glass fiber reinforced resin. In this case it is highly important that a substantial amount of the fibers that construct said one or more pockets, as single pockets or forming one or more said stacks of pockets, continue to extend out from the pockets and out to surrounding structure. The fibers that connect a pocket to surrounding structure can extend out from the pocket in 6 paths that are highly effective in achieving the desired properties of the pocket area. Path 1 is highly effective in creating the vertical strength a pocket and surrounding structure requires, closes the bottom of a pocket and connects the structure below and above a pocket together while paths 2, 3, 4, 5 and 6 are highly effective in strengthening and stiffening a pocket against input moment, such as r described in FIG. 40. Paths 2, 3, 4 and 5 have θ=45°+/−10° and path 6 has an angle of 0°+/−10° at the same location as paths 2, 3, 4, 5 make their turn. In one variation of the embodiment shown in FIGS. 66-67 the path 2, 3 or 6 fibers run either straight up or down (when said vehicle suspension system is in a vertical position in relation to the ground i.e. the rotational axis of the suspended wheel being parallel to the ground and front and rear wheels of said vehicle are horizontal to one another) for up to 50 millimeters, before turning to any of the direction described in FIGS. 67-68 or FIG. 71.

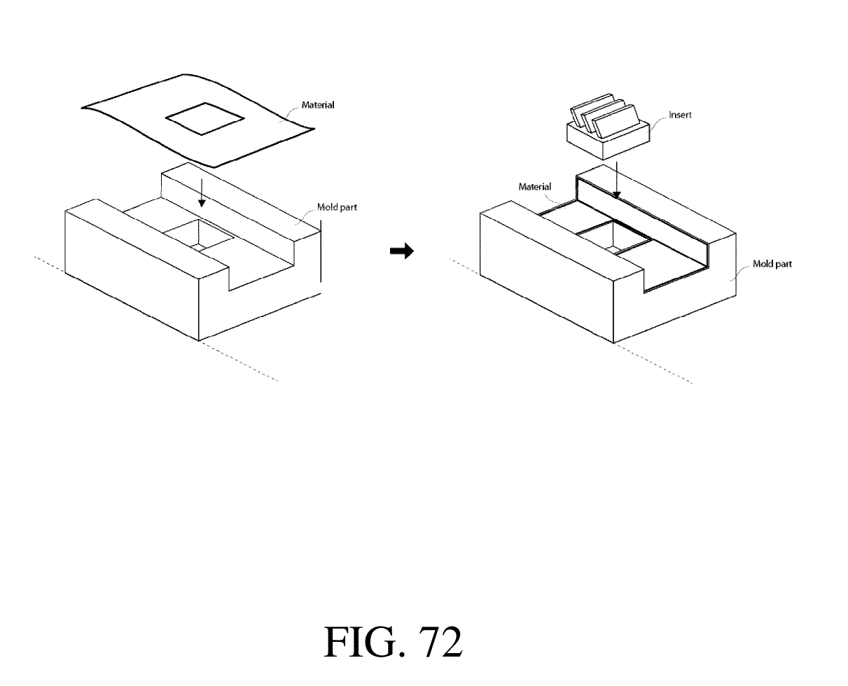

FIG. 72 show one variation of the embodiments from FIGS. 64-71 there is a monocoque structure material present tightly around the one or more pockets in the molding process before the specific construction of one or more pockets begins.

In one variation of the embodiments in FIGS. 64-72 the angle of fiber paths 2-5 is θ=45°+/−20°

In one variation of the embodiments in FIGS. 64-72 the angle of fiber path 6 is 0°+/−25°

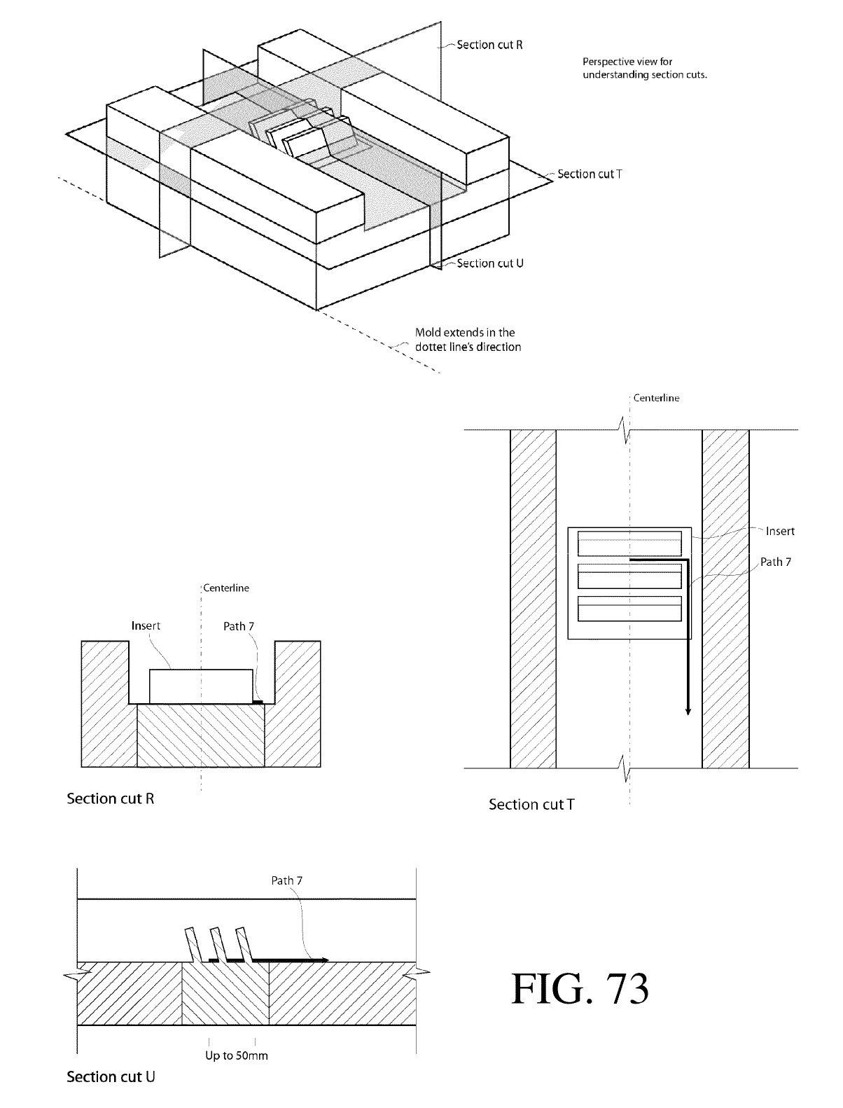

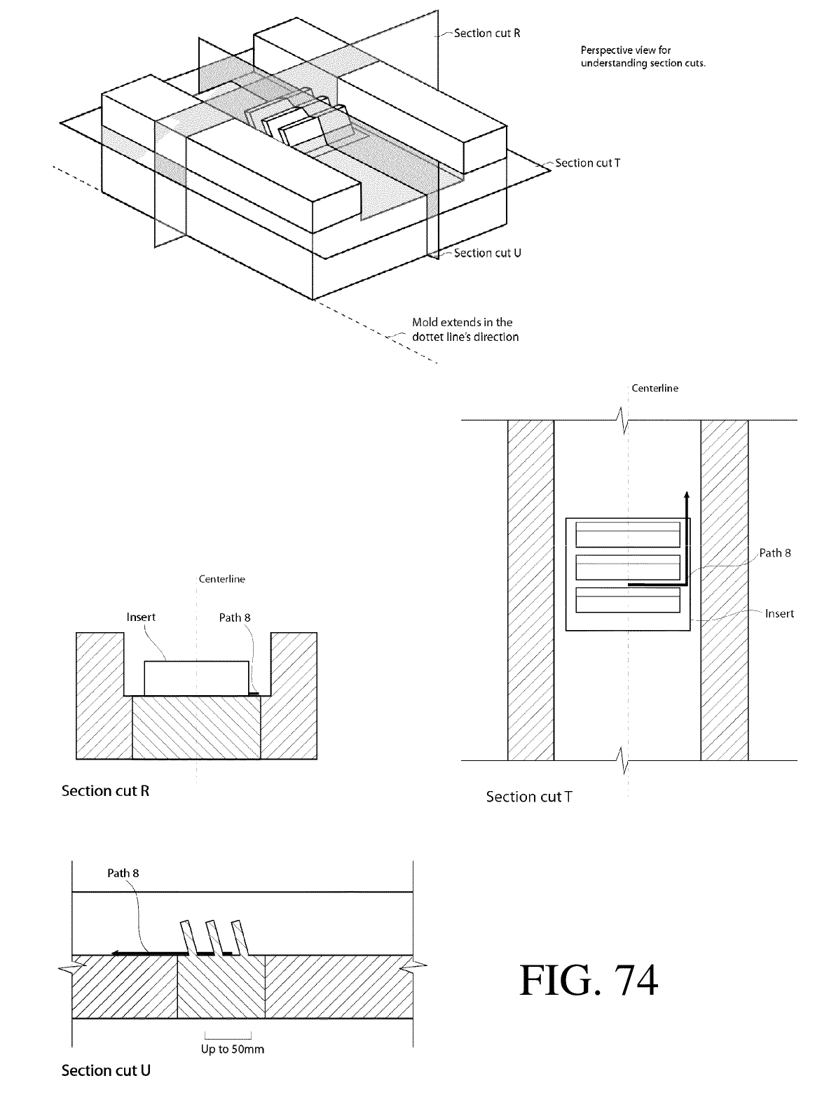

FIGS. 73-74 show one variation of the embodiments shown in FIGS. 64-72 the structure further incorporates path 7 and 8 fibers that run straight up or down, respectively, creating a beam-like structure past, and perpendicular to, the end of one or more pockets. These path 7 and 8 fibers can be placed between any of the other path fibers, or on top or below, and they further strengthen and stiffen a pocket vertically and against lateral input forces to the said suspension system, without adding material along the top or bottom surfaces of a pocket.

The path 1, 2, 3, 4, 5, 6, 7 and 8 fibers can be placed in any order around the said short and thin beams, each path can be used multiple times and these fibers may be used in combination with any other fibers.

In one variation of the embodiments in FIGS. 64-74 path 1 fibers are placed around the said short and thin beams before placing fibers along one or more of the paths 2, 3, 4, 5 and 6 in narrow filaments or tapes on top of the path 1 fibers.

In one variation of the embodiments in FIGS. 64-74 fibers along one or more of the paths 2, 3, 4, 5 and 6 are laid down around the said short and thin beams in narrow filaments or tapes before placing path 1 fibers.

In one variation of the embodiments in FIGS. 64-74 fibers along one or more of the paths 2, 3, 4, 5 and 6 are laid down around the said short and thin beams in narrow filaments or tapes before placing path 1 fibers on top of the fibers that are along one or more of the paths 2, 3, 4, 5 and 6. Then some additional fibers along one or more of the paths 2, 3, 4, 5 and 6 are placed on top of the path 1 fibers in narrow filaments or tapes.

In one variation of the embodiments in FIGS. 64-74 path 1 fibers are laid down around the said short and thin beams in narrow filaments or tapes before placing fibers that are along one or more of the paths 2, 3, 4, 5 and 6 on top of the path 1 fibers. Then some additional path 1 fibers are placed on top of the fibers that are along one or more of the paths 2, 3, 4, 5 and 6.

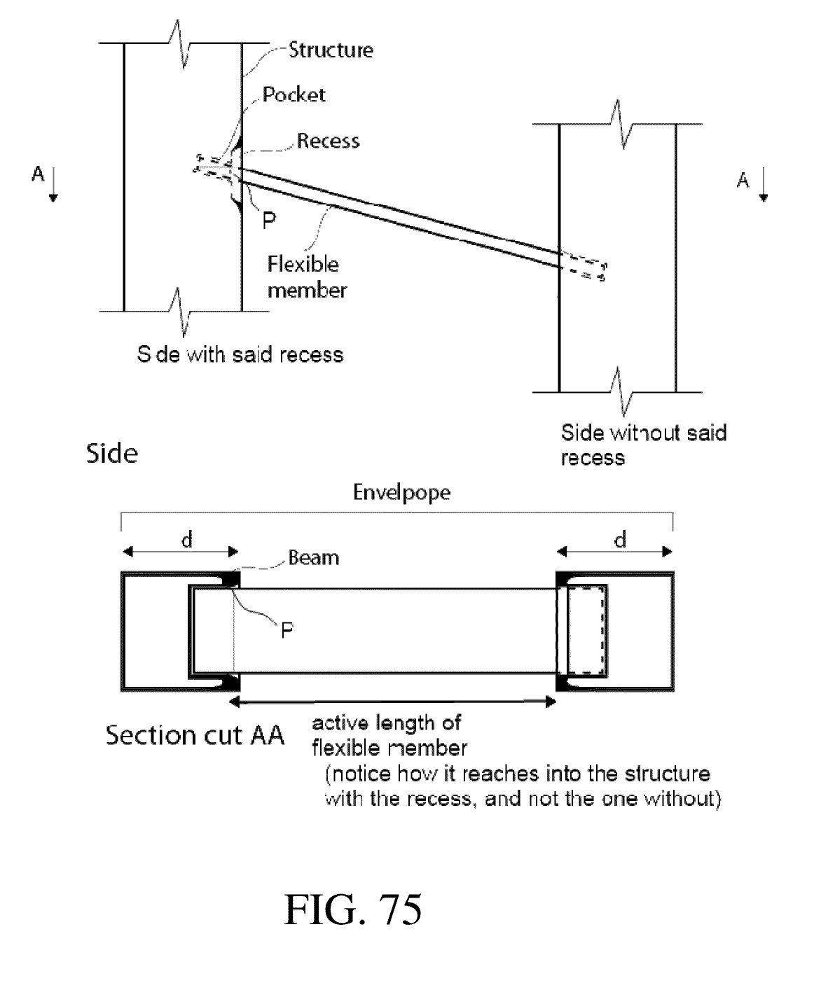

FIG. 75—In one embodiment of the said suspension one or more out of the said one or more pockets are located in a slight recess, up to 7 mm deep, into its surrounding said wheel or frame structure. The reason for this is twofold. Firstly this increases the active length of a flexible member, assuming a given combined envelope length of a flexible member and surrounding structures on each end and given depth, d, of the structure surrounding the said one or more pockets (see figure for description of the term envelope length). Secondly, the beam like structural elements that go past, and perpendicular to, the end of said one or more pockets significantly increase the structural strength and rigidity around the edge, P, of the pocket opening. This edge and its proximity is a highly stressed location of the structure when the said suspension system is under load during usage.

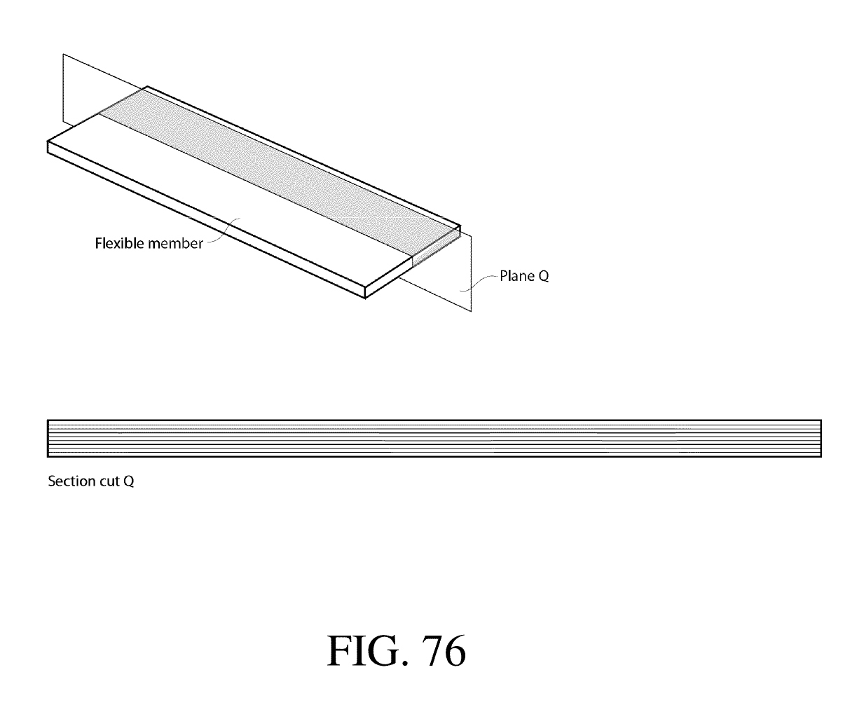

FIG. 76—Shows a cross section through the plane Q of one embodiment of one or more out of the said two or more flexible members of the said suspension system where said one or more flexible members are made of a fiber reinforced resin material such as, but not limited to, carbon fiber reinforced epoxy, glass fiber reinforced epoxy, flax fiber reinforced, boron reinforced epoxy or basalt reinforced epoxy. The said one or more flexible members are constructed from several layers of said fiber reinforced resin layers.

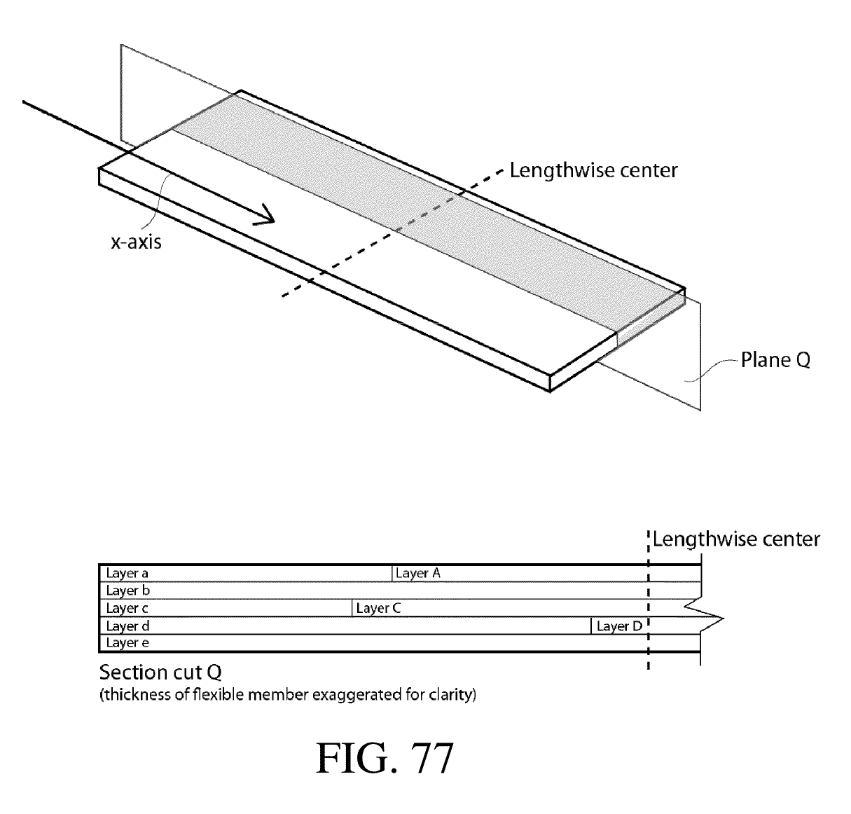

FIG. 77—Shows an example of one or more out of said at least two composite material flexible members constructed from several layers of resin impregnated fiber layers. Said layers arranged in such a manner so that one or more individual layers starting at an end of said flexible member do not reach all the way towards the lengthwise center of the said flexible member but are replaced with layers with its fibers at a greater angle from the length direction of the flexible member. As an example of a flexible member constructed in this manner the figure has capital letter denoted layers; A, C and D with a larger angle of its fibers to the length direction of the flexible member than the layers denoted; a, c and d, respectively. This proposed configuration increases torsional rigidity of a said flexible member and its flexibility in the intended direction of the suspension travel, without sacrificing flexural strength in the intended direction of the suspension travel. Fibers running along the length direction of said flexible member, the x-axis, are most effective taking up forces in the intended suspension direction of the said suspension system, while fibers with a greater angle from the x-axis are relatively more effective in taking up torsional loads on the said flexible member. As the flexural stress on said flexible members in the configuration of said suspension system is increasing towards the ends of said flexible members it is beneficial to emphasize flexural strength at the ends of said flexible members but replace some of that flexural strength (as it is not needed) for torsional rigidity closer to the lengthwise center of said flexible member. This makes for a flexible member that achieves higher flexural strength and/or higher torsional rigidity for a given flexibility in the intended movement direction of the suspension, or if rather desired higher flexibility for a given strength and/or torsional rigidity, than would otherwise be possible with the fiber layers running the full length of said flexible member with a substantially fixed fiber angle.

In one variation of the embodiment shown in FIG. 77 a said fiber layer is not substituted for a layer with a larger fiber angle towards the length direction of the said flexible member. Instead the layer itself has its fibers that are closer to the lengthwise center at a greater said angle, i.e. the said angle of fibers is not fixed within the layer but increases towards the lengthwise center.

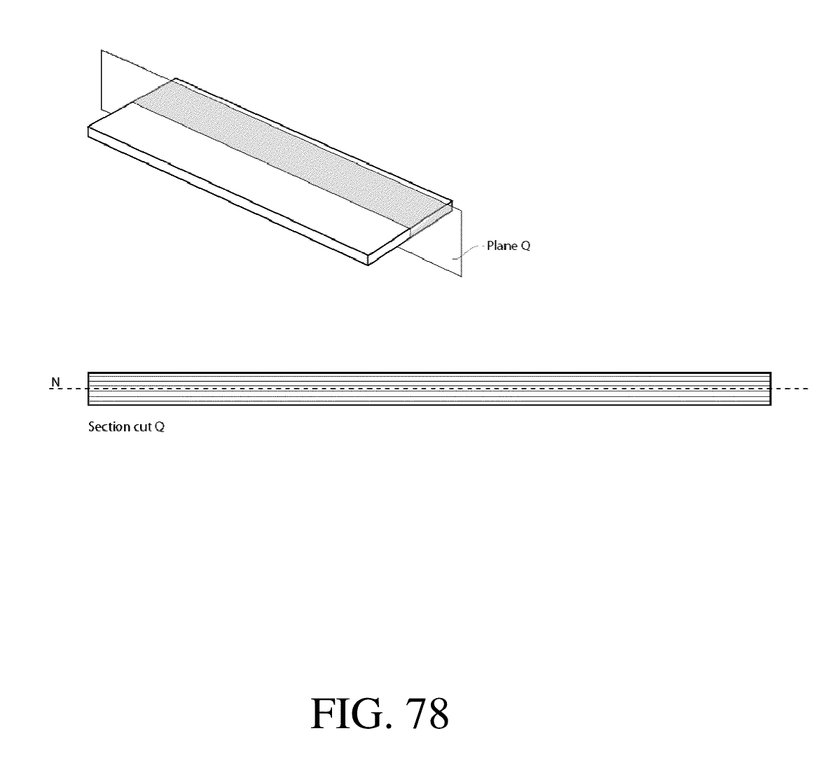

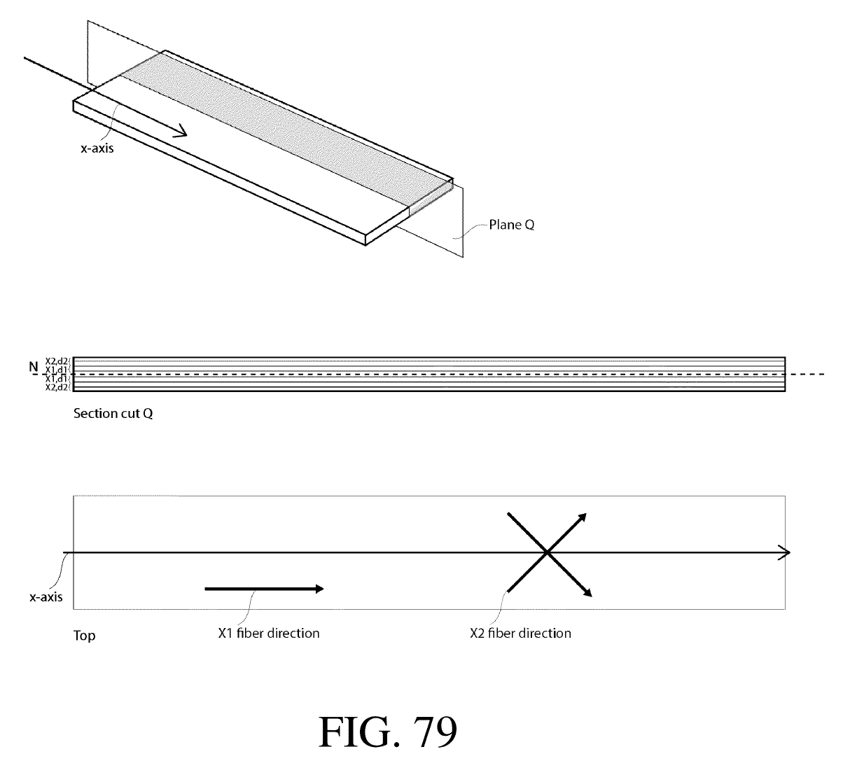

FIG. 78—In one version of the embodiments in FIGS. 76-77 the said fiber reinforced resin layers are substantially symmetric around the said one or more out of the said two or more flexible members' neutral axis, N.

FIG. 79—In one version of the embodiment in FIGS. 76-78 an X1 number of layers with a combined thickness of d1 closest to the neutral axis of the said one or more flexible members have their fiber orientations at 0°+/−10° from the x-axis (an axis in the length direction of said flexible member) and an X2 number of layers with a combined thickness of d2, located further from the centerline, have their fiber directions at either +45°+/−10° and/or −45°+/−10° from the x-axis, these layers can either be unidirectional fiber layers where +45°+/−10° and −45°+/−10° layers can be alternated to achieve a balanced layup, or they can be layers of woven material where +45°+/−10° and −45°+/−10° direction fibers are included in the same layer. This proposed configuration emphasizes torsional rigidity of the flexible member, as the layers have a larger effect on the characteristics of the flexible member as they are further from the neutral axis. Fibers running along the length direction of said flexible member, the x-axis, are most effective taking up forces in the intended suspension direction of the said suspension system, while fibers substantially close to +/−45° from the x-axis are most effective in taking up torsional loads on the said one or more flexible member.

In one version of the embodiments from FIGS. 76-79 X1 and X2 are chosen so that the thicknesses d1 and d2 have a ratio: d2/d1 between 0.25 and 0.35.

In one version of the embodiments from FIGS. 76-79 X1 and X2 are chosen so that the thicknesses d1 and d2 have a ratio: d2/d1 between 0.35 and 0.45.

In one version of the embodiments from FIGS. 76-79 X1 and X2 are chosen so that the thicknesses d1 and d2 have a ratio: d2/d1 between 0.45 and 0.6.

In one version of the embodiments from FIG. 76-79 the X1 number of layers have their fiber orientations at 0°+/−25° from the x-axis (an axis in the length direction of said flexible member) and the X2 number of layers have their fiber directions at either +45°+/−20° and/or −45°+/−20° from the x-axis.

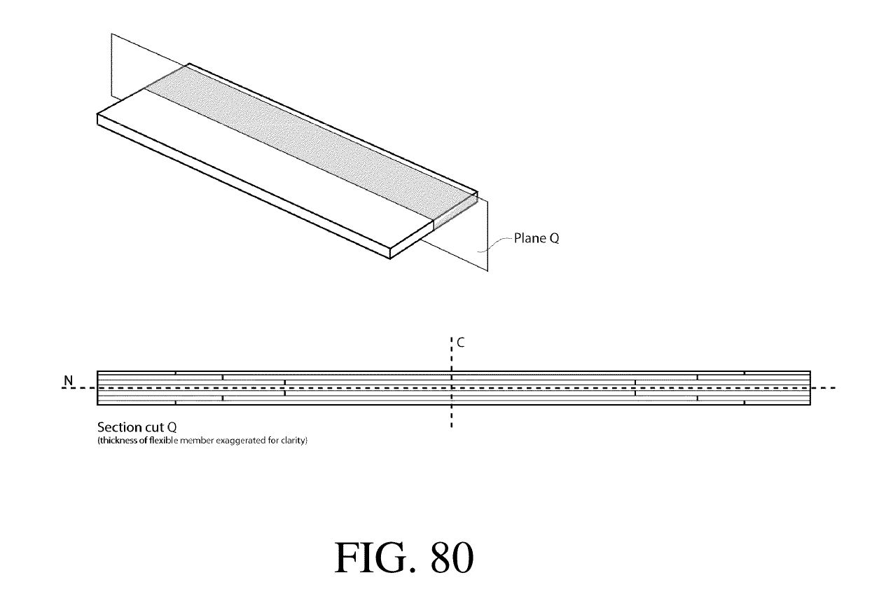

FIG. 80—In one variation of the embodiments in FIGS. 76-79 the said X1 and X2 numbers of layers vary along the length of the said one or more flexible members, making the ratio d2/d1 variable along the length of the flexible member. The flexible member is substantially symmetric around the centerline C. The ratio d2/d1 increases gradually as we approach the centerline C. As the flexural load of the said one or more flexible members increases linearly from the centerline C towards the end of the flexible member when load in the intended suspension direction of the said suspension system is applied (as seen in classical beam theory), this configuration makes the flexural strength and rigidity of the flexible member better address the loading scenario. The said one or more flexible members will get more flexible in the intended direction of the said suspension close to the centerline C than it is at the ends. This makes for a flexible member that achieves higher flexural strength and/or higher torsional rigidity for a given flexibility in the intended movement direction of the suspension, or if rather desired higher flexibility for a given strength and/or torsional rigidity, than would otherwise be possible with a fixed d2/d1 ratio along its length.

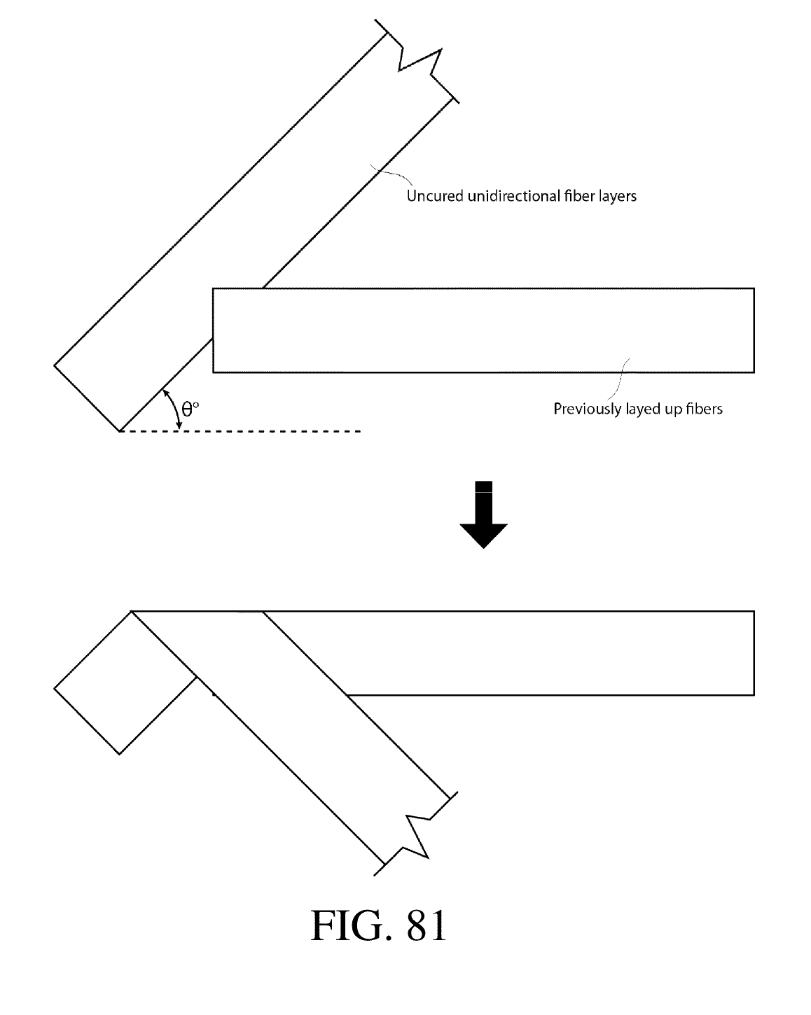

FIG. 81 Describes one variation of a lay-up process for the embodiments in FIGS. 76-80 where one or more out of the said two or more flexible members of the said suspension system have uncured unidirectional fiber reinforced resin layer strips, with its fiber direction substantially along the length of said strip, wrapped at an angle θ around previously layed-up fiber reinforced resin layers. This manufacturing process makes for a single flexible member, or a long flexible member that can be cut into several shorter flexible members, that have fibers at an angle θ that do not end on the long edge of the said flexible member but fold over the edge and continue onwards towards the end of the said flexible member on the other side. This makes the resulting flexible member less susceptible to develop fatigue cracks from the fiber ends close to the long edges.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. A front wheel vehicle suspension system comprising:
a frame structure including a two legged fork,
wherein the front wheel vehicle suspension system further comprises:
a wheel structure comprising wheel structure beams positioned posterior to the two legged fork,
two sets of at least two spaced apart flexible members extending between the respective one of said two legs of said two legged fork and said wheel structure beams such that said two sets of flexible members are located on respective lateral sides of a suspended wheel,
wherein each of said wheel structure beams comprises hub mounts located above one or more out of said at least two flexible members on each side of the suspended wheel and below one or more out of said at least two flexible members on each side of the suspended wheel and where said hub mounts are positioned opposingly to each other and are adapted to receive a connection to one another via the hub of the suspended wheel, where each of said flexible members is mounted into attachment pockets in said two legged fork and said wheel structure beams.

2. A front wheel suspension system according to claim 1, wherein each of said flexible members is rigidly mounted into separate one or more of said pockets, e.g. such that no more than one flexible member is mounted to each pocket.

3. A front wheel suspension system according to claim 1 or 2,
wherein said attachment pockets are substantially deeper than the height of their openings.

4. A front wheel suspension system according to claim 1, wherein said attachment pockets are a seamless integrated part of the surrounding rigid structure of said two legged fork and said wheel structure beams.

5. A front wheel suspension system according to claim 1, wherein said two legged fork and/or said wheel structure beams are hollow rigid structures and where one or more out of said at least two flexible members pass through an opening on one or more out of said hollow rigid structures and extend into said hollow rigid structures all the way to the opposite wall inside the respective hollow structure where they are rigidly mounted into said one or more pockets.

6. A front wheel suspension system according to claim 1, wherein said attachment pockets are made of resin impregnated fibers running up or down and/or laterally out from the attachment pockets and out to surrounding structure, when the rotational axis of the suspended wheel is parallel to the ground and front and rear wheels of said vehicle both in contact with ground.

7. A front wheel vehicle suspension system according to claim 1, wherein said at least two flexible members comprise three or more flexible members and where two or more out of said three or more flexible members are separately rigidly mounted into two or more spaced apart pockets above one another in a rigid structure of said two legged fork and/or said wheel structure beams, where the distance between the most proximate points of two adjacent pockets of the said two or more tightly spaced pockets is between 1 mm and 30 mm, such as 2-10 mm.

8. A front wheel vehicle suspension system according to claim 1, wherein at least two flexible members are mutually rigidly mounted into a single pocket in said two legged fork and said wheel structure beams and where the at least two flexible members are spaced apart from one another in each of said pockets by means of spacer means contained within said pockets.

9. A front wheel vehicle suspension system according to claim 1, wherein said one or more pockets have a draft angle of between 0 and 3 degrees, so that said pockets are never substantially wider at the bottom than at the opening.

10. A front wheel vehicle suspension system according to claim 1, wherein said one or more pockets each include one or more extrusions measuring between 0.05 mm to 4 mm, such as 0.1-2 mm in height, where said extrusions protrude into the said one or more pockets from the top and/or bottom surfaces.

11. A front wheel vehicle suspension system according to claim 1, wherein one or more out of said at least two flexible members each include one or more extrusions measuring between 0.05 mm to 4 mm, such as 0.1-2 mm in height sticking out from the lower and/or upper surfaces of one or more out of said at least two flexible members perpendicular to said one or more out of said at least two flexible members width and length and are located so that they get partially or fully submerged into said one or more pockets.

12. A front wheel vehicle suspension system according to claim 1, wherein said extrusions are separate parts and are adapted to be inserted into said one or more pockets during or prior to the bonding process between said flexible members and said pockets.

13. A vehicle comprising a suspension system according to claim 1.

14. A vehicle according to claim 13, wherein said vehicle is selected from being:
a bike,
a bicycle,
a motorbike,
a motorized bicycle,
a scooter or
a tricycle.

15. A front wheel vehicle suspension assembly comprising:
a two legged fork,
wherein the front wheel vehicle suspension assembly further comprises:
a wheel structure comprising wheel structure beams adapted to be positioned posterior to the two legged fork,
two sets of at least two spaced apart flexible members adapted to extend between the respective one of said two legs of said two legged fork and said wheel structure beams such that said two sets of flexible members are located on respective lateral sides of a suspended wheel,
wherein each of said wheel structure beams comprises hub mounts adapted to be located above one or more out of said at least two flexible members on each side of the suspended wheel and below one or more out of said at least two flexible members on each side of the suspended wheel and such that said hub mounts are positioned opposingly to each other and are adapted to receive a connection to one another via the hub of the suspended wheel, where each of said flexible members is adapted to be mounted into attachment pockets in said two legged fork and said wheel structure beams.
